(19) United States
(12) Patent Application Publication
(10) Pub. No.: US 2024/0304401 A1
(43) Pub. Date: Sep. 12, 2024

(54) SOUND DEVICE

(71) Applicant: AlphaTheta Corporation, Yokohama-shi, Kanagawa (JP)

(72) Inventors: Kenji Sasaki, Yokohama-shi, Kanagawa (JP); Nao Takagi, Yokohama-shi, Kanagawa (JP)

(21) Appl. No.: 18/549,486

(22) PCT Filed: Mar. 9, 2021
(86) PCT No.: PCT/JP2021/009390

§ 371 Date: Sep. 7, 2023

(51) Int. Cl. H01H 25/00; G10H 1/34; H01H 25/04

(52) U.S. Cl. CPC H01H 25/002; G10H 1/34; H01H 25/041; H01H 2025/043; H01H 2231/018

(57) ABSTRACT

The acoustic device includes: an operator; a state switching mechanism that performs switching of operation modes of the operator in response to a switching operation; and an operational-feeling switching mechanism that performs switching of operational feelings of the operator in response to the switching operation, along with the switching of the operation modes performed by the state switching mechanism.

### TECHNICAL FIELD

The disclosure relates to an acoustic device.

### BACKGROUND ART

An acoustic device such as a mixer including a rotary operator in which an operating dial is configured to be rotatable has been known (see, for example, Patent Literature 1).

In the mixer according to Patent Literature 1, the rotary operator is what is called a rotary volume. In the mixer according to Patent Literature 1, the rotary operator is used for, for example, each of a high-frequency band adjuster that adjusts a sound volume of a high-frequency band of music inputted to the acoustic device, a medium-frequency band adjuster that adjusts a sound volume of a medium-frequency band of the inputted music, a low-frequency band adjuster that adjusts a sound volume of a low-frequency band of the inputted music, and an effect amount adjuster that adjusts an effect amount of an effect to be added to a sound to be inputted to a corresponding channel.

### CITATION LIST

### Patent Literature(s)

Patent Literature 1: International Publication No. WO 2009/234681

### SUMMARY OF THE INVENTION

### Problem(s) to be Solved by the Invention

An operational feeling of a rotary operator varies depending on a user such as a DJ (Disc Jockey) who uses an acoustic device, and a utilization mode of the acoustic device in which the rotary operator is used varies depending on the user. In contrast, if an operational feeling of the rotary operator is set to a predetermined operational feeling when the acoustic device is used in a predetermined utilization mode, the user may easily use the acoustic device.

In view of such issues, an acoustic device with high usability has been demanded.

### Means for Solving the Problem(s)

An acoustic device according to an embodiment of the disclosure includes: an operator; a state switching mechanism configured to perform switching of operation modes of the operator in response to a switching operation; and an operational-feeling switching mechanism configured to perform switching of operational feelings of the operator in response to the switching operation, along with the switching of the operation modes performed by the state switching mechanism.

### BRIEF DESCRIPTION OF DRAWINGS

FIG. 1 is a plan view of a mixer according to a first exemplary embodiment.

FIG. 2 is a plan view of a rotary operator and a state switching mechanism according to the first exemplary embodiment.

FIG. 3 is a perspective view of the rotary operator according to the first exemplary embodiment.

FIG. 4 is a perspective view of the rotary operator according to the first exemplary embodiment in which a cover and a fixing member are separated.

FIG. 5 is a plan view of the rotary operator according to the first exemplary embodiment in which the cover and the fixing member are removed.

FIG. 6 is a plan view of a casing according to the first exemplary embodiment.

FIG. 7 is a perspective view of an operator body according to the first exemplary embodiment.

FIG. 8 is a side view of a rotator according to the first exemplary embodiment.

FIG. 9 is a perspective view of a restriction switching mechanism according to the first exemplary embodiment.

FIG. 10 is a plan view of the restriction switching mechanism according to the first exemplary embodiment.

FIG. 11 is an exploded perspective view of the restriction switching mechanism according to the first exemplary embodiment.

FIG. 12 is an exploded perspective view of the restriction switching mechanism according to the first exemplary embodiment.

FIG. 13 is a cross-sectional view of the rotator and the restriction switching mechanism according to the first exemplary embodiment.

FIG. 14 is a schematic diagram illustrating a position of a contact portion when the rotator according to the first exemplary embodiment is rotated in a counterclockwise-side range.

FIG. 15 is a cross-sectional view of the rotary operator according to the first exemplary embodiment.

FIG. 16 is an exploded perspective view of the operator body and an operational-feeling switching mechanism according to the first exemplary embodiment.

FIG. 17 is an exploded perspective view of the operator body and the operational-feeling switching mechanism according to the first exemplary embodiment.

FIG. 18 is a perspective view of a portion of the state switching mechanism and one rotary operator according to the first exemplary embodiment.

FIG. 19 is an exploded perspective view of a portion of the state switching mechanism according to the first exemplary embodiment.

FIG. 20 is a plan view of the state switching mechanism according to the first exemplary embodiment that is in a state in which a slide operator is disposed at a first switching position.

FIG. 21 is a plan view of the state switching mechanism according to the first exemplary embodiment that is in a state in which the slide operator is disposed at a second switching position.

FIG. 22 is a plan view of the state switching mechanism according to the first exemplary embodiment that is in a state in which the slide operator is disposed at a third switching position.

FIG. 23 is a schematic diagram illustrating a cylindrical portion of an operator body of a rotary operator included in a mixer according to a second exemplary embodiment.

FIG. 24 is a perspective view of a modification of an operator and a first biasing member.

### DESCRIPTION OF EMBODIMENT(S)

### First Exemplary Embodiment

Hereinafter, a first exemplary embodiment of the disclosure will be described with reference to the attached drawings.

### Overall Configuration of Acoustic Device

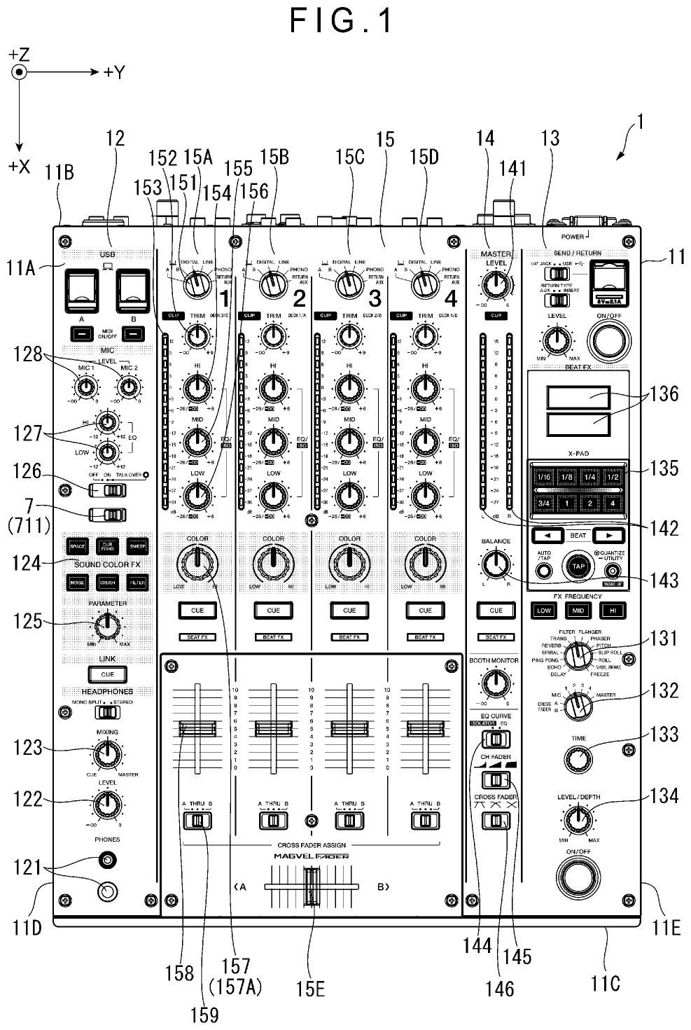

FIG. 1 is a plan view of an acoustic device 1 according to the exemplary embodiment.

The acoustic device 1 according to the exemplary embodiment is a mixer that mixes pieces of music supplied from a music playback device such as an analog player, a CD player, or a computer that executes music playback software, and outputs an audio signal corresponding to the mixed music. The acoustic device 1 adds a predetermined effect to each of the inputted pieces of music.

As illustrated in FIG. 1, the acoustic device 1 includes a casing 11, a microphone adjuster 12, an effect processor 13, a master adjuster 14, and an equalizer adjuster 15.

### Configuration of Casing

The casing 11 has a substantially rectangular parallelepiped shape and contains therein a controller (not illustrated) that controls an operation of the acoustic device 1. The casing 11 includes a top surface 11A, an upper surface 11B, a lower surface 11C, a left side surface 11D, a right side surface 11E, and an unillustrated bottom surface.

Exposed on the top surface 11A are the microphone adjuster 12, the effect processor 13, the master adjuster 14, and the equalizer adjuster 15.

On the upper surface 11B, a terminal to which a music playback device and a music operating device such as a DJ player are couplable is provided.

In the following description, three directions orthogonal to each other are defined as a +X direction, a +Y direction, and a +Z direction. The +Z direction is a direction from the bottom surface toward the top surface 11A. That is, the +Z direction is a direction perpendicular to the top surface 11A. The +X direction is a direction from the upper surface 11B toward the lower surface 11C, and the +Y direction is a direction from the left side surface 11D toward the right side surface 11E.

Although not illustrated, an opposite direction of the +X direction is a −X direction, an opposite direction of the +Y direction is a −Y direction, and an opposite direction of the +Z direction is a −Z direction.

### Configuration of Microphone Adjuster

The microphone adjuster 12 includes a headphone terminal 121, a sound volume adjuster 122, a mixing adjuster 123, a master effect switcher 124, a master effect amount adjuster 125, a microphone switcher 126, a microphone equalizer adjuster 127, and a microphone sound volume adjuster 128. On the microphone adjuster 12, a slide operator 711 is exposed.

To the headphone terminal 121, unillustrated headphones are coupled.

The sound volume adjuster 122 adjusts a sound volume outputted from the headphones.

The mixing adjuster 123 adjusts a balance of the sound volume outputted from the headphones, that is, a balance between an output sound volume of a channel whose CUE button is pressed and an output sound volume of a master channel.

The master effect switcher 124 includes six buttons. The master effect switcher 124 performs switching from effects to be applied to pieces of music of all channels provided in the equalizer adjuster 15 to an effect preset for a pressed button. Examples of the effect to be switched to by the master effect switcher 124 include effects classified in “SOUND COLOR EFFECT”.

The master effect amount adjuster 125 adjusts an effect amount that is an application amount of the effect that has been switched to by the master effect switcher 124.

The microphone switcher 126 performs on/off switching on a microphone coupled to the acoustic device 1.

The microphone equalizer adjuster 127 adjusts a volume of a sound to be inputted from the microphone in accordance with a frequency.

The microphone sound volume adjuster 128 adjusts a volume of a sound to be outputted from the microphone.

The slide operator 711 is included in a state switching mechanism 7 to be described later. The slide operator 711 is provided to be slidable in the ±Y directions, and switches operation modes of the effect adjuster 157 and operational feelings of the effect adjuster 157 in accordance with a position of the slide operator 711. A configuration of the state switching mechanism 7 including the slide operator 711 and a configuration of the effect adjuster 157 will be described in detail later.

### Configuration of Effect Processor

The effect processor 13 adds an effect to the inputted music. Examples of the effect to be added by the effect processor 13 include effects classified in “BEAT EFFECT”.

The effect processor 13 includes an effect switcher 131, a channel switcher 132, an effect time setter 133, an effect amount adjuster 134, a magnification setter 135, and a display 136.

The effect switcher 131 is a switch for selecting an effect to be added to the music.

The channel switcher 132 selects, out of all channels with which the equalizer adjuster 15 is provided, a channel in which the effect is to be added to the music.

The effect time setter 133 sets a duration of adding the selected effect.

The effect amount adjuster 134 adjusts an effect amount of the selected effect.

The magnification setter 135 sets a beat magnification to synchronize a timing of adding the effect based on BPM of the inputted music. Examples of the settable beat magnification include 1 beat, 2 beats, ½ beats, and ¼ beats of BPM of the music.

The display 136 displays the selected effect, or BPM of the inputted music. In the exemplary embodiment, the display 136 displays the name of the effect selected in the effect switcher 131, BPM of the music or the beat magnification set by the magnification setter 135.

### Configuration of Master Adjuster

The master adjuster 14 adjusts music as a whole to be outputted from the acoustic device 1. The master adjuster 14 includes a master sound volume adjuster 141, a level indicator 142, a master sound volume balance adjuster 143, an equalizer switcher 144, a first characteristic switcher 145, and a second characteristic switcher 146.

The master sound volume adjuster 141 adjusts a sound volume of the whole music to be outputted from the acoustic device 1.

The level indicator 142 displays left and right output sound volumes of the music to be outputted from the acoustic device 1.

The master sound volume balance adjuster 143 adjusts balance between the left and right output sound volumes of the music to be outputted from the acoustic device 1.

The equalizer switcher 144 switches equalizer curves.

The first characteristic switcher 145 switches curve characteristics of the volume fader 158 of the equalizer adjuster 15.

The second characteristic switcher 146 switches curve characteristics when switching is performed by a cross fader 15E to be described later.

### Configuration of Equalizer Adjuster

The equalizer adjuster 15 performs an equalizer adjustment process for each channel on the music inputted to the acoustic device 1. The equalizer adjuster 15 includes a first channel adjuster 15A that adjusts a first channel, a second channel adjuster 15B that adjusts a second channel, a third channel adjuster 15C that adjusts a third channel, a fourth channel adjuster 15D that adjusts a fourth channel, and a cross fader 15E.

The channel adjusters 15A to 15D are each coupled to, for example, the above-described music playback device or the above-described music operating device such as the DJ player. It is possible for each of the channel adjusters 15A to 15D to perform equalizer adjustment on the music to be inputted. The channel adjusters 15A to 15D each include an input switcher 151, a level adjuster 152, a level indicator 153, a high-frequency band adjuster 154, a medium-frequency band adjuster 155, a low-frequency band adjuster 156, an effect adjuster 157, a volume fader 158, and a cross fader switcher 159.

The input switcher 151 switches input sources. Specifically, the input switcher 151 switches input-source music playback devices among music playback devices including, without limitation, an analog player coupled to a phono terminal of the acoustic device 1, a CD player coupled to a line terminal, and a computer connected to a USB terminal.

The level adjuster 152 adjusts an input level of the music inputted from the music playback device selected by the input switcher 151.

The level indicator 153 displays the input level adjusted by the level adjuster 152.

The high-frequency band adjuster 154 adjusts a sound volume of a high-frequency band of the inputted music. The high-frequency band is, for example, a frequency band higher than or equal to 4649 Hz.

The medium-frequency band adjuster 155 adjusts a sound volume of a medium-frequency band of the inputted music. The medium-frequency band is, for example, a frequency band higher than 284 Hz and lower than 4649 Hz.

The low-frequency band adjuster 156 adjusts a sound volume of a low-frequency band of the inputted music. The low-frequency band is, for example, a frequency band lower than or equal to 284 Hz.

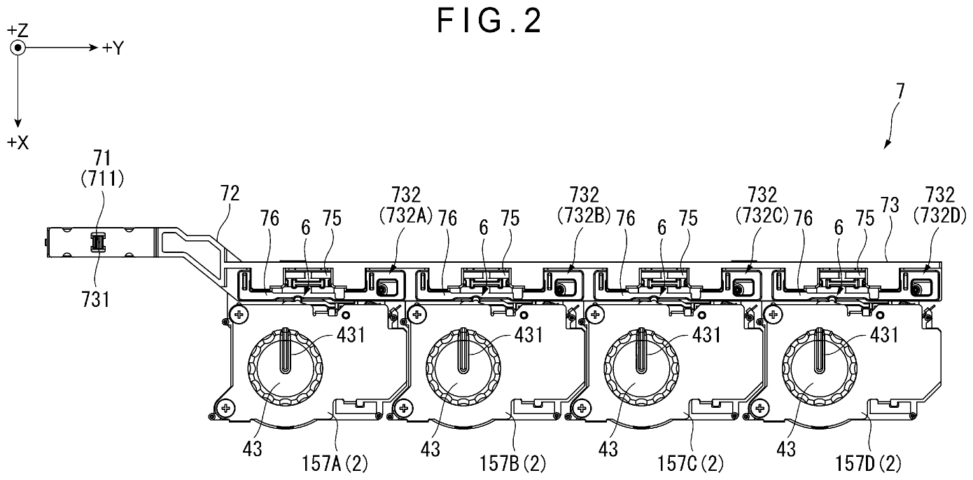

The effect adjuster 157 adjusts an effect amount of an effect set for the corresponding one of the channel adjusters 15A to 15D. In other words, the acoustic device 1 includes an effect adjuster 157A that is the effect adjuster 157 of the first channel adjuster 15A, an effect adjuster 157B that is the effect adjuster 157 of the second channel adjuster 15B, an effect adjuster 157C that is the effect adjuster 157 of the third channel adjuster 15C, and an effect adjuster 157D that is the effect adjuster 157 of the fourth channel adjuster 15D. The effect adjuster 157 includes a rotary operator 2 (see FIG. 2) to be described later.

The volume fader 158 adjusts a volume of a sound to be outputted from the corresponding one of the channel adjusters 15A to 15D.

The cross fader switcher 159 switches an output destination of the corresponding one of the adjusters 15A to 15D to one of an A side (a left side) or a B side (a right side) of the cross fader 15E.

The cross fader 15E includes an operator that is movable to the left and to the right. As the operator is moved to the left, a proportion of a sound volume of the channel switched to the A side increases in terms of the sound volume to be outputted from the acoustic device 1. Further, as the operator is moved to the right, a proportion of a sound volume of the channel switched to the B side increases in terms of the sound volume to be outputted from the acoustic device 1.

### Internal Configuration of Acoustic Device

FIG. 2 is a plan view of the rotary operator 2 and the state switching mechanism 7 included in the casing 11.

As illustrated in FIG. 2, the acoustic device 1 includes the rotary operator 2 in which a dial 43 is exposed on the top surface 11A (see FIG. 1) toward an outside of the casing 11, and an operational-feeling switching mechanism 6 and the state switching mechanism 7 provided inside the casing 11.

The rotary operator 2 is an operator to be rotated by a user. The rotary operator 2 configures each of the effect adjusters 157A to 157D. That is, the acoustic device 1 includes four rotary operators 2 arranged along the +Y direction.

The operational-feeling switching mechanism 6 is provided correspondingly to each of the multiple rotary operators 2. The operational-feeling switching mechanism 6 switches operational feelings obtained when the rotary operator 2 is operated.

The state switching mechanism 7 switches states of the rotary operator 2, and specifically, switches operation modes of the rotary operator 2. The operation mode of the rotary operator 2 may also be regarded as the operation mode of the acoustic device 1 that includes the rotary operator 2. As will be described in detail later, the state switching mechanism 7 switches the operation modes of each rotary operator 2 and causes each operational-feeling switching mechanism 6 to operate in response to the switching operation of the user on the state switching mechanism 7.

Hereinafter, the rotary operator 2, the operational-feeling switching mechanism 6, and the state switching mechanism 7 will be described.

### Configuration of Rotary Operator

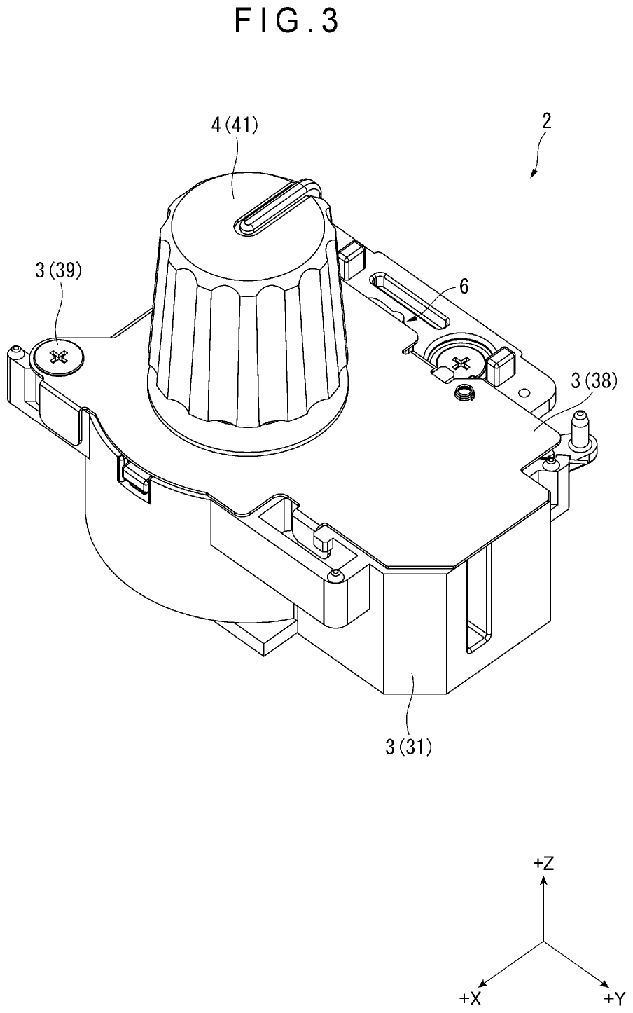

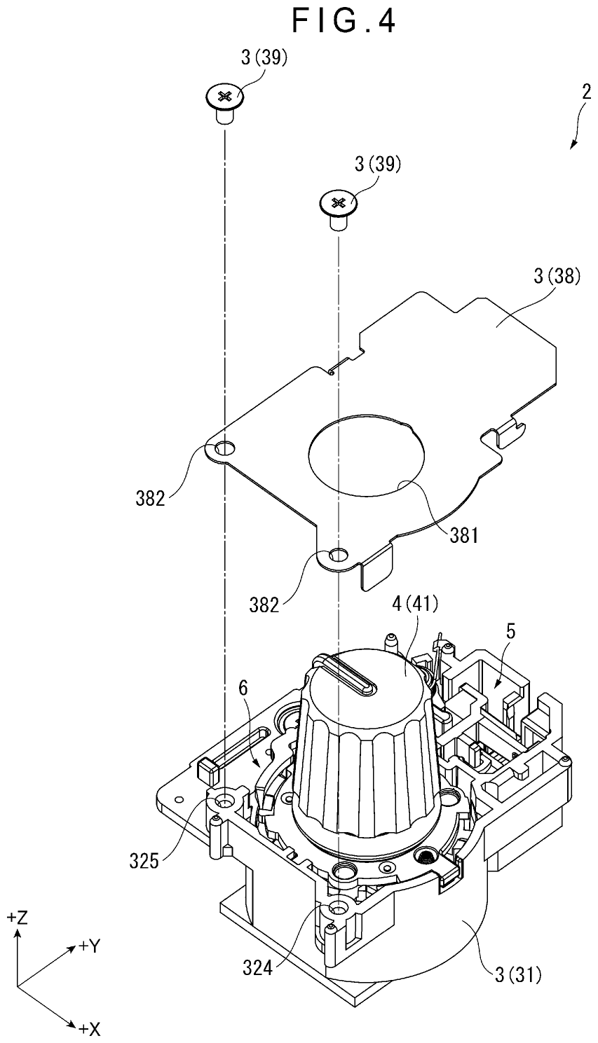

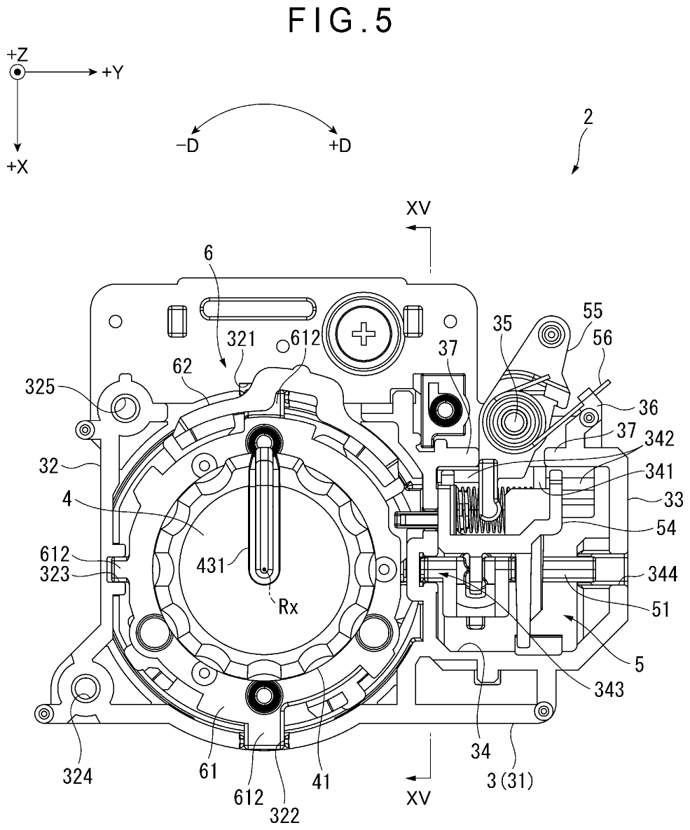

FIG. 3 is a perspective view of the rotary operator 2. FIG. 4 is a perspective view of the rotary operator 2 in which a cover 38 and a fixing member 39 of a casing 3 are separated. FIG. 5 is a plan view of the rotary operator 2 viewed from the +Z direction in which the cover 38 and the fixing member 39 are removed.

As illustrated in FIGS. 3 to 5, the rotary operator 2 includes the casing 3, an operator body 4, and a restriction switching mechanism 5.

### Configuration of Casing

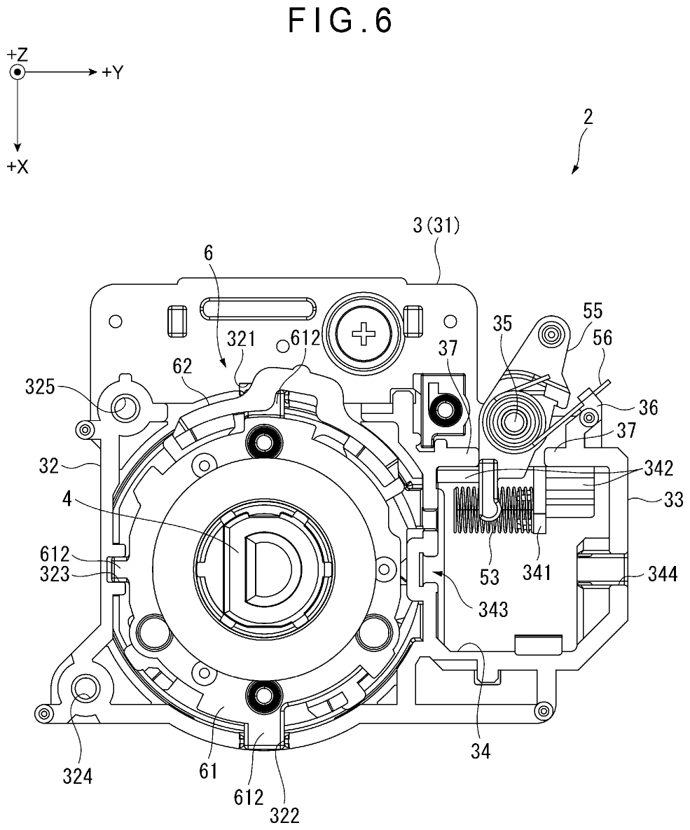

FIG. 6 is a plan view of the casing 3 viewed from the +Z direction. It is to be noted that, in FIG. 6, some members that are engaged with the casing 3 out of members included in the rotary operator 2 are illustrated together with the casing 3.

The casing 3 has a substantially rectangular parallelepiped shape and supports the operator body 4, the restriction switching mechanism 5, and the operational-feeling switching mechanism 6. As illustrated in FIGS. 3 to 6, the casing 3 includes a casing body 31 in which the operator body 4 is disposed, and as illustrated in FIGS. 3 and 4, the casing 3 includes the cover 38 and the fixing member 39.

As illustrated in FIGS. 5 and 6, the casing body 31 includes a first arrangement portion 32 and a second arrangement portion 33.

The first arrangement portion 32 is a part having a substantially rectangular shape as viewed from the +Z direction and provided in the casing 3, and is a part where the operator body 4 and a portion of the operational-feeling switching mechanism 6 are disposed. The first arrangement portion 32 is open in the +Z direction. The first arrangement portion 32 includes guides 321, 322, and 323 and fixing portions 324 and 325.

The guides 321 to 323 are each a recess that is provided at a periphery in the +Z direction of the first arrangement portion 32 and opens in the +Z direction. On the periphery in the +Z direction of the first arrangement portion 32, the guide 321 is provided at a position in the −X direction, the guide 322 is provided at a position in the +X direction, and the guide 323 is provided at a position in the −Y direction.

In each of the guides 321 to 323, a to-be-guided portion 612 included in a click plate 61, which will be described later, of the operational-feeling switching mechanism 6 is disposed. When a movement base 62 to be described later of the operational-feeling switching mechanism 6 is rotated clockwise or counterclockwise as viewed from the +Z direction, the guides 321 to 323 guide movement in the ±Z directions of the click plate 61 while preventing the click plate 61 that engages with the movement base 62 from rotating together with the movement base 62.

The fixing portions 324 and 325 are each a part that fixes the fixing member 39. The fixing member 39 fixes the cover 38 to the casing body 31. In the exemplary embodiment, the fixing portions 324 and 325 are each a threaded hole into which the fixing member 39 that is a screw is screwed.

The second arrangement portion 33 is provided in the +Y direction with respect to the first arrangement portion 32, and is a part where the restriction switching mechanism 5 is disposed. The second arrangement portion 33 includes a support 34, a lever support 35, a locking portion 36, and a range defining portion 37.

The support 34 supports, for example, a contact piece 51 and a holding member 54 of the restriction switching mechanism 5. The support 34 passes through the casing 3 along the +Z direction. The support 34 includes a holding portion 341, guides 342 and 344, and a guide hole 343.

The holding portion 341 is provided on an inner surface in the −X direction of the support 34. The holding portion 341 holds an end in the +Y direction of a second biasing member 53 to be described later. As will be described in detail below, the holding portion 341 and the second biasing member 53 are disposed inside the holding member 54 that is disposed within the support 34.

The guide 342 is provided in the +Y direction with respect to the holding portion 341, and is provided continuously with the holding portion 341 in the +Y direction with respect to the holding portion 341. Each guide 342 guides movement in the ±Y directions of the holding member 54.

The guide hole 343 is an opening that communicates the first arrangement portion 32 and the second arrangement portion 33 with each other. The guide hole 343 is provided to be long in the +Z direction. A contact portion 515 of the contact piece 51 to be disposed in the support 34 is inserted through the guide hole 343 toward the first arrangement portion 32. It is to be noted that an inner diameter of the guide hole 343 in the +X direction substantially matches a dimension of the contact portion 515 in the +X direction.

The guide 344 is a recess that is provided at a position in the +Y direction of a periphery of the second arrangement portion 33, and opens in the +Y direction and +Z direction. The guide 344 supports the contact piece 51 to be movable in the ±Y directions and to be movable in the ±Z directions.

The lever support 35 rotatably supports a switching member 55 of the restriction switching mechanism 5. Specifically, the lever support 35 supports the switching member 55 to be rotatable clockwise and counterclockwise, as viewed from the +Z direction.

The locking portion 36 is provided in the lever support 35 to lock one end of a third biasing member 56. The third biasing member 56 is a torsion coil spring that biases counterclockwise the switching member 55. The other end of the third biasing member 56 is locked to the switching member 55.

Two range defining portions 37 are provided at positions in the +X direction with respect to the lever support 35. The range defining portions 37 are separated from each other in the +Y direction. The range defining portions 37 sandwich the switching member 55 supported by the lever support 35 supported in the +Y direction, thereby defining a rotation range of the switching member 55.

The cover 38 is fixed to the casing body 31 from the +Z direction by two fixing members 39, as illustrated in FIG. 4. The cover 38 is a member that covers a portion of the operational-feeling switching mechanism 6 to be described later in the +Z direction and retains a portion of the operational-feeling switching mechanism 6 within the first arrangement portion 32. The cover 38 has an opening 381 having a circular shape through which a portion of a rotating body 44 is to be inserted, and has two holes 382 through which the fixing members 39 are to be inserted.

### Configuration of Operator Body

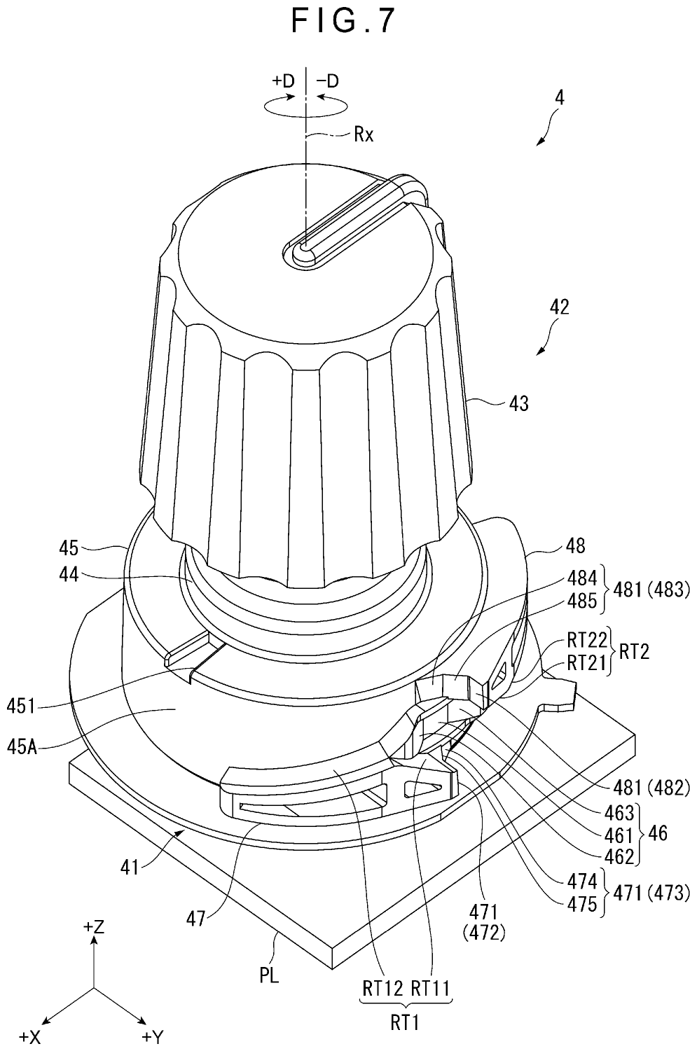

FIG. 7 is a perspective view of the operator body 4.

The operator body 4 is a rotary volume that is to be operated by the user and outputs a rotation angle with respect to a reference position. The operator body 4 includes a base 41 and a rotator 42.

The base 41 supports the rotator 42 to be rotatable about a rotation axis Rx extending along the +Z direction, and is fixed to a board PL. The base 41 includes a detector (not illustrated) that detects the rotation angle of the rotator 42. It is to be noted that a known technique is employable for a configuration of the detector that detects the rotation angle, and explanation thereof will thus be omitted. Further, the board PL is a portion of the controller that configures the acoustic device 1 or a board that is electrically coupled to the controller.

The rotator 42 is rotated by the user about the rotation axis Rx. The rotator 42 includes the dial 43 where the user pinches, and the rotating body 44 to which dial 43 is attached and which is rotated integrally with the dial 43.

The dial 43 has an indicating line 431 that indicates a rotation position of the rotator 42. As illustrated in FIG. 5, if a position of the rotator 42 when the indicating line 431 is parallel to the −X direction and faces the −X direction is set as a reference position, the rotator 42 is configured in such a manner as to be rotatable clockwise substantially 150 degrees from the reference position, for example, and rotatable counterclockwise substantially 150 degrees from the reference position, for example. That is, the reference position is a position at which a range from the reference position to a position where the clockwise rotation of the rotator 42 about the rotation axis Rx is allowed as viewed from the +Z direction is equal in length to a range from the reference position to a position where the counterclockwise rotation of the rotator 42 about the rotation axis Rx is allowed as viewed from the +Z direction. In other words, the reference position is a position at which a rotation range from the reference position to a clockwise rotation limit is equal in length to a rotation range from the reference position to a counterclockwise rotation limit. The reference position corresponds to a predetermined position according to the disclosure.

In the following explanation, a clockwise direction viewed from the +Z direction is set as a +D direction, and a counterclockwise direction viewed from the +Z direction is set as a −D direction.

The rotating body 44 includes a cylindrical portion 45 having a cylindrical shape about the rotation axis Rx.

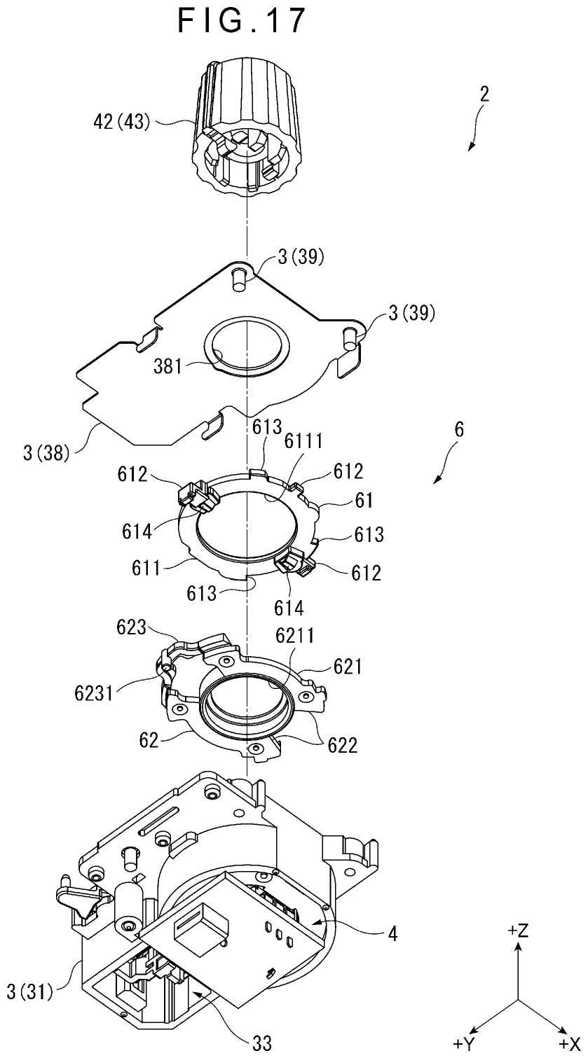

The cylindrical portion 45 includes a fitting portion 451 on the plane in the +Z direction. In the fitting portion 451, a protrusion 614 (see FIG. 17) to be described later provided in the click plate 61 is fitted in association with the rotation of the rotator 42.

The cylindrical portion 45 includes, on an outer circumferential surface 45A about the rotation axis Rx: a recess 46 recessed in a direction toward the rotation axis Rx from the outer circumferential surface 45A; and path forming portions 47 and 48 each protruding radially outward about the rotation axis Rx from the outer circumferential surface 45A.

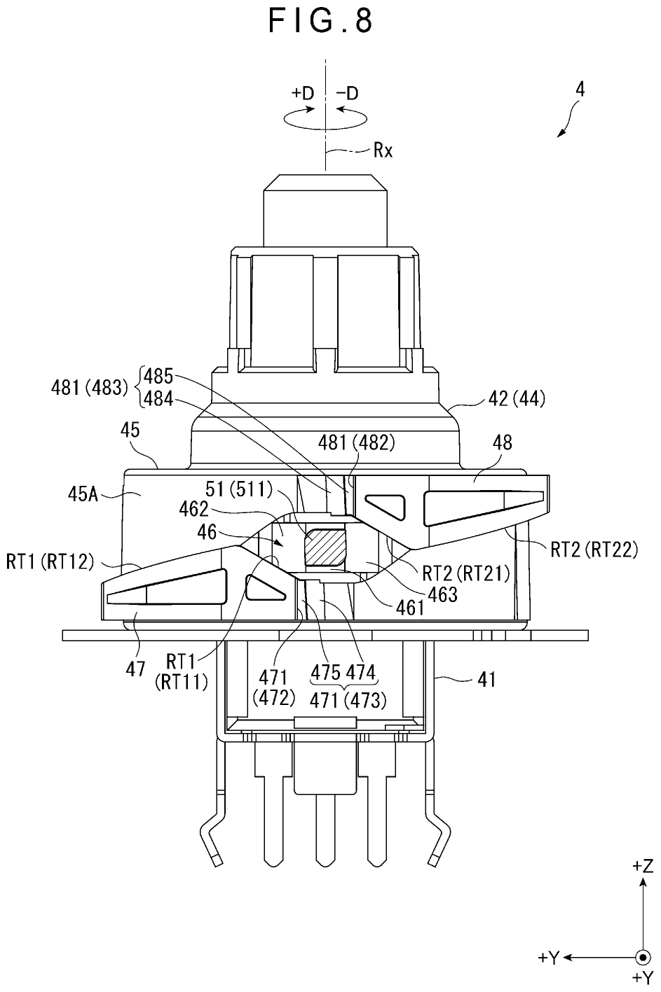

FIG. 8 is a side view of the rotator 42 viewed from the +Y direction.

The contact piece 51 fits into the recess 46 when the rotator 42 is located at the reference position. The recess 46 is provided at the center in the +Z direction of the cylindrical portion 45. The recess 46 has a bottom 461 and inclined portions 462 and 463.

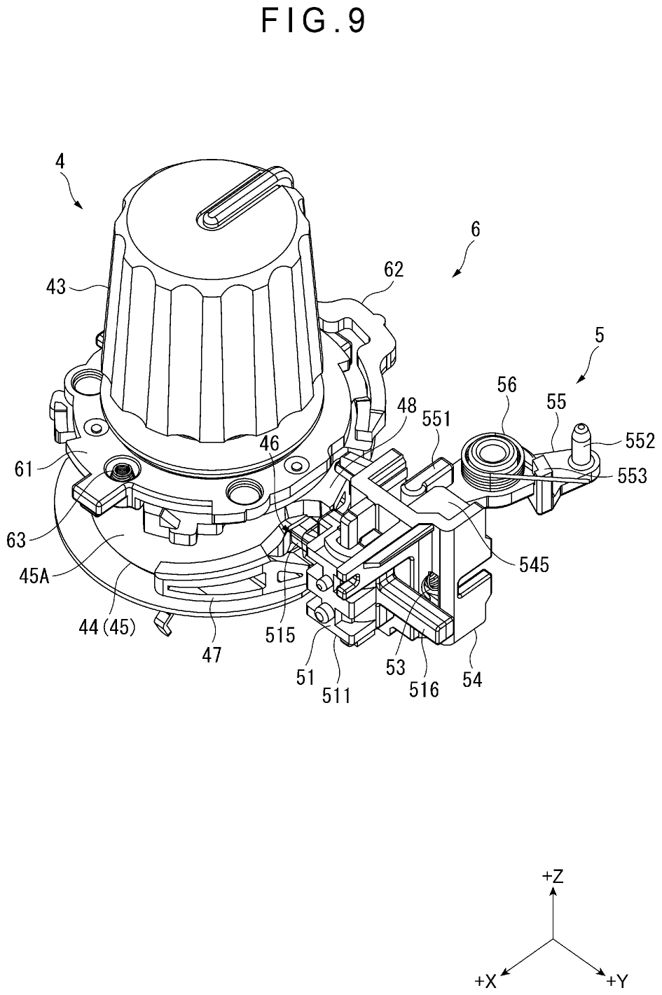

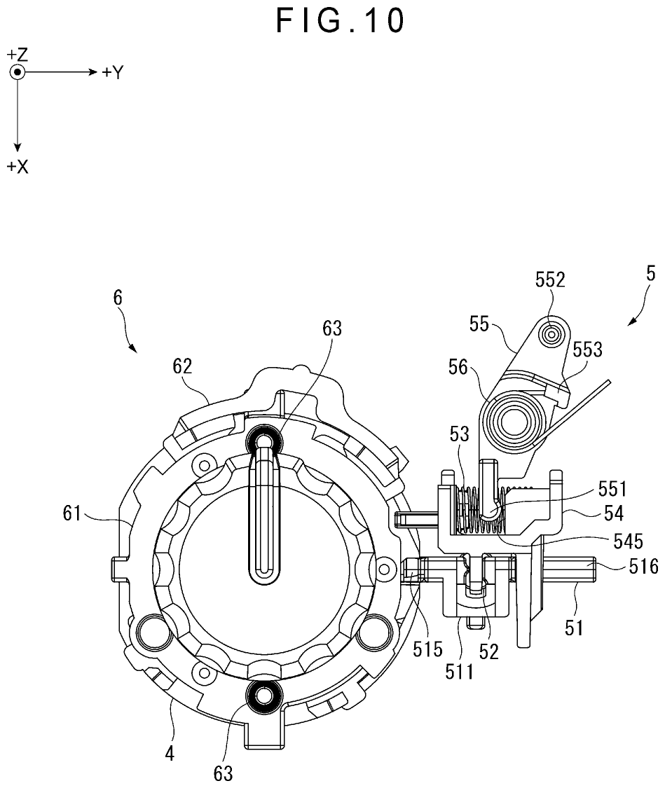

The bottom 461 is a part that is located nearest to the rotation axis Rx in the recess 46, and is flat. The bottom 461 may be provided with the contact portion 515 (see FIGS. 9 and 10) that comes into contact with the outer circumferential surface 45A in the contact piece 51.

The inclined portion 462 is disposed in the +D direction with respect to the bottom 461. The inclined portion 462 is inclined in such a manner as to be separated from the rotation axis Rx toward the +D direction. That is, the inclined portion 462 is inclined in such a manner as to be located radially outward about the rotation axis Rx toward the +D direction. When the rotator 42 is rotated in the −D direction, the inclined portion 462 leads the contact portion 515 to a first path RT11 of the path forming portion 47. The contact portion 515 moves relatively in the +D direction with respect to the rotator 42.

The inclined portion 463 is disposed in the −D direction with respect to the bottom 461. The inclined portion 463 is inclined in such a manner as to be separated from the rotation axis Rx toward the −D direction. That is, the inclined portion 463 is inclined in such a manner as to be located radially outward about the rotation axis Rx toward the −D direction. When the rotator 42 is rotated in the +D direction, the inclined portion 463 leads the contact portion 515 to a first path RT21 of the path forming portion 48. The contact portion 515 moves relatively in the −D direction with respect to the rotator 42.

The path forming portions 47 and 48 each protrude radially outward from the outer circumferential surface 45A. The path forming portions 47 and 48 respectively form movement paths RT1 and RT2 of the contact portion 515 (see FIGS. 9 and 10) when the rotator 42 is rotated. That is, the rotator 42 has a cylindrical cam structure in which the movement paths RT1 and RT2 are provided. The movement paths RT1 and RT2 are each inclined with respect to a circumferential direction about the rotation axis Rx, and each allow the contact piece 51 to move along the rotation axis Rx in accordance with the rotation of the rotator 42.

As illustrated in FIGS. 7 and 8, the path forming portions 47 and 48 are provided to be point-symmetric about the recess 46.

The path forming portion 47 forms the movement path RT1 of the contact portion 515 when the rotator 42 is rotated in a rotation range from the reference position to the rotation limit in the −D direction. The path forming portion 47 is provided continuously with the inclined portion 462. The path forming portion 47 comes into contact with a part in the −Z direction of the contact portion 515.

Hereinafter, the rotation range from the reference position to the rotation limit in the −D direction is referred to as a counterclockwise-side range of the rotator 42. Further, the rotation range from the reference position to the rotation limit in the +D direction is referred to as a clockwise-side range of the rotator 42.

The movement path RT1 includes the first path RT11 and a second path RT12.

The first path RT11 is provided continuously with the inclined portion 462 of the recess 46. The first path RT11 is inclined in such a manner as to be located in the +Z direction toward the +D direction. That is, the first path RT11 is inclined with respect to the circumferential direction about the rotation axis Rx. An end in the +D direction of the first path RT11 is coupled to the second path RT12. Thus, when the rotator 42 is rotated in the −D direction, the contact portion 515 moves in the +D direction along the first path RT11 to reach the second path RT12.

The second path RT12 is a path inclined with respect to the circumferential direction about the rotation axis Rx in such a manner as to be located in the −Z direction toward the +D direction. The second path RT12 is longer in the +D direction than the first path RT11. That is, the second path RT12 is inclined with respect to the circumferential direction about the rotation axis Rx. When the rotator 42 is rotated farthest in the −D direction, the contact portion 515 moves further in the +D direction than the second path RT12. A position in the +Z direction of the contact piece 51 at this time is the same as a position in the +Z direction of the contact piece 51 when the contact portion 515 is disposed on the bottom 461 owing to biasing force of a first biasing member 52 to be described later.

Further, an end in the +D direction of the path forming portion 47 is disposed in the −Z direction relative to an end in the −Z direction of the contact portion 515 when the rotation axis Rx is set as the center and the contact piece 51 is disposed at a second position. Thus, if the rotator 42 is rotated farthest in the −D direction and is thereafter rotated in the +D direction, the contact portion 515 comes into contact with a surface in the +Z direction of the path forming portion 47 and is moved along the second path RT12. However, the disclosure is not limited thereto, and when the rotator 42 is rotated farthest in the −D direction, the contact portion 515 may be disposed at a predetermined part in the second path RT12.

It is to be noted that the second path RT12 is provided radially inward about the rotation axis Rx relative to the first path RT11. That is, the second path RT12 is provided at a position closer to the rotation axis Rx than the first path RT11.

When the rotator 42 is rotated in the +D direction in the counterclockwise-side range, the second path RT12 leads the contact portion 515 moving in the −D direction to a restricting portion 481 of the path forming portion 48.

The path forming portion 48 forms the movement path RT2 of the contact portion 515 when the rotator 42 is rotated in a rotation range from the reference position to the rotation limit in the +D direction. The path forming portion 48 is provided continuously with the inclined portion 463. The path forming portion 48 comes into contact with a part in the +Z direction of the contact portion 515.

Hereinafter, a range from the reference position to the rotation limit in the +D direction of the rotator 42 is referred to as a clockwise-side range of the rotator 42.

The movement path RT2 includes the first path RT21 and a second path RT22.

The first path RT21 is provided continuously with the inclined portion 463 of the recess 46. The first path RT21 is inclined in such a manner as to be located in the −Z direction toward the −D direction. That is, the first path RT21 is inclined with respect to the circumferential direction about the rotation axis Rx. An end in the −D direction of the first path RT21 is continuous with the second path RT22. Thus, when the rotator 42 is rotated in the +D direction, the contact portion 515 moves in the −D direction along the first path RT21 to reach the second path RT22. It is to be noted that the first path RT21 is provided radially outward about the rotation axis Rx relative to the second path RT22.

The second path RT22 is a path inclined with respect to the circumferential direction about the rotation axis Rx in such a manner as to be located in the +Z direction toward the −D direction. The second path RT22 is longer in the −D direction than the first path RT21. When the rotator 42 is rotated farthest in the +D direction, the contact portion 515 moves further in the −D direction than the second path RT22. A position in the +Z direction of the contact piece 51 at this time is the same as a position when the contact piece 51 is disposed at the second position owing to the biasing force of the first biasing member 52 to be described later. Further, an end in the −D direction of the path forming portion 48 is disposed in the −Z direction relative to an end in the +Z direction of the contact portion 515 that has the rotation axis Rx as its center and disposed at the second position. Thus, if the rotator 42 is rotated farthest in the +D direction and is thereafter rotated in the −D direction, the contact portion 515 comes into contact with a surface in the −Z direction of the path forming portion 48 and is moved along the second path RT22. However, the disclosure is not limited thereto, and when the rotator 42 is rotated farthest in the +D direction, the contact portion 515 may be disposed at a predetermined part in the second path RT22.

When the rotator 42 is rotated in the −D direction in the clockwise-side range, the second path RT22 leads the contact portion 515 moving in the +D direction to a restricting portion 471 of the path forming portion 47.

The path forming portion 47 further includes the restricting portion 471 provided at an end in the −D direction of the path forming portion 47. The restricting portion 471 is provided in the −Z direction with respect to the recess 46.

The restricting portion 471 includes a restricting surface 472 and a guide surface 473.

The restricting surface 472 is substantially perpendicular to the circumferential direction about the rotation axis Rx. When the rotator 42 is rotated in the −D direction and reaches the reference position in the clockwise range of the rotator 42, the contact piece 51 moved relatively in the +D direction with respect to the rotator 42 comes into contact with the restricting surface 472. Thus, the restricting portion 471 restricts the contact piece 51 from further moving in the +D direction and restricts the rotator 42 from rotating in the −D direction from the reference position. A position of the contact piece 51 when the contact portion 515 comes into contact with the restricting portion 471 is set as a first position in the clockwise-side range of the rotator 42. The first position in the clockwise-side range is in the −Z direction relative to a position of the contact piece 51 when the contact portion 515 is disposed on the bottom 461. It is to be noted that the position of the contact piece 51 when the contact portion 515 is disposed on the bottom 461 is set as the second position.

The guide surface 473 guides, to the restricting surface 472, the contact piece 51 moved along the movement path RT2 formed by the path forming portion 48 and the outer circumferential surface 45A. The guide surface 473 includes a first guide surface 474 and a second guide surface 475.

The first guide surface 474 is continuous with the second path RT22 and the outer circumferential surface 45A. The first guide surface 474 intersects the circumferential direction about the rotation axis Rx in such a manner as to be located radially outward about the rotation axis Rx toward the +D direction.

The second guide surface 475 is provided between the first guide surface 474 and the restricting surface 472, and is continuous with the first guide surface 474 and the restricting surface 472. The second guide surface 475 intersects the circumferential direction about the rotation axis Rx in such a manner as to be located radially outward about the rotation axis Rx toward the +D direction. An inclination angle of the second guide surface 475 with respect to the circumferential direction about the rotation axis Rx is greater than an inclination angle of the first guide surface 474 with respect to the circumferential direction.

The contact piece 51 that reaches the guide surface 473 from the second path RT22 further moves relatively in the +D direction with respect to the rotator 42, thereby moving along the guide surface 473 in the +Y direction away from the rotator 42, and also reaching a position in contact with the restricting surface 472. If rotating force in the −D direction applied to the rotator 42 is reduced in this state, the biasing force of the first biasing member 52 to be described later causes the contact portion 515 to move in the +Z direction beyond the path forming portion 48 that forms the second path RT22, and to reach the bottom 461. That is, the contact piece 51 reaches the second position.

As with the path forming portion 47, the path forming portion 48 further includes the restricting portion 481 provided at an end in the +D direction of the path forming portion 48. The restricting portion 481 is provided in the +Z direction with respect to the recess 46.

The restricting portion 481 includes a restricting surface 482 and a guide surface 483.

The restricting surface 482 is substantially perpendicular to the circumferential direction about the rotation axis Rx. When the rotator 42 is rotated in the +D direction and reaches the reference position in the counterclockwise-side range of the rotator 42, the contact piece 51 moved relatively in the −D direction with respect to the rotator 42 comes into contact with the restricting surface 482. Thus, the restricting portion 481 restricts the contact piece 51 from further moving in the −D direction, and restricts the rotator 42 from rotating in the +D direction from the reference position. A position of the contact piece 51 when the contact portion 515 comes into contact with the restricting portion 481 is set as a first position in the counterclockwise-side range of the rotator 42. The first position in the counterclockwise-side range is in the +Z direction with respect to the second position.

As with the guide surface 473, the guide surface 483 guides, to the restricting surface 482, the contact piece 51 moved along the movement path RT1 formed by the path forming portion 47 and the outer circumferential surface 45A. The guide surface 483 includes a first guide surface 484 and a second guide surface 485.

The first guide surface 484 is continuous with the second path RT22 and the outer circumferential surface 45A. The first guide surface 484 intersects the circumferential direction about the rotation axis Rx in such a manner as to be located radially outward about the rotation axis Rx toward the −D direction.

The second guide surface 485 is provided between the first guide surface 484 and the restricting surface 482, and is continuous with the first guide surface 484 and the restricting surface 482. The second guide surface 485 intersects the circumferential direction about the rotation axis Rx in such a manner as to be located radially outward about the rotation axis Rx toward the +D direction. An inclination angle of the second guide surface 485 with respect to the circumferential direction about the rotation axis Rx is greater than an inclination angle of the first guide surface 484 with respect to the circumferential direction.

The contact piece 51 that reaches the guide surface 483 from the second path RT12 further moves relatively in the −D direction with respect to the rotator 42, thereby moving along the guide surface 483 in the +Y direction away from the rotator 42, and also reaching a position in contact with a restricting surface 481A. If rotating force in the +D direction applied to the rotator 42 is reduced in this state, the biasing force of the first biasing member 52 to be described later causes the contact portion 515 to move in the −Z direction beyond the path forming portion 47 that forms the second path RT12, and to reach the bottom 461. That is, the contact piece 51 reaches the second position.

As described above, the outer circumferential surface 45A of the rotator 42 is provided with the movement paths RT1 and RT2. The movement paths RT1 and RT2 are each inclined with respect to the circumferential direction about the rotation axis Rx. The rotator 42 is rotated about the rotation axis Rx. The contact portion 515 that moves along the movement paths RT1 and RT2 will be described in detail later.

### Configuration of Restriction Switching Mechanism

FIG. 9 is a perspective view of the restriction switching mechanism 5, and FIG. 10 is a plan view of the restriction switching mechanism 5 viewed from the +Z direction. It is to be noted that FIGS. 9 and 10 are each a view of the restriction switching mechanism 5 engaged with the operator body 4.

In response to the switching operation on the state switching mechanism 7, the restriction switching mechanism 5 performs switching between a restricted state in which the rotation of the rotator 42 is restricted by the restricting portions 471 and 481 and an unrestricted state in which the rotation of the rotator 42 is not restricted. That is, the restriction switching mechanism 5 performs switching between the restricted state in which the rotation of the rotator 42 is restricted at the reference position and the unrestricted state in which the rotation of the rotator 42 is not restricted at the reference position.

As illustrated in FIGS. 9 and 10, the restriction switching mechanism 5 includes the contact piece 51, the first biasing member 52, the second biasing member 53, the holding member 54, the switching member 55, and the third biasing member 56.

### Configuration of Contact Piece

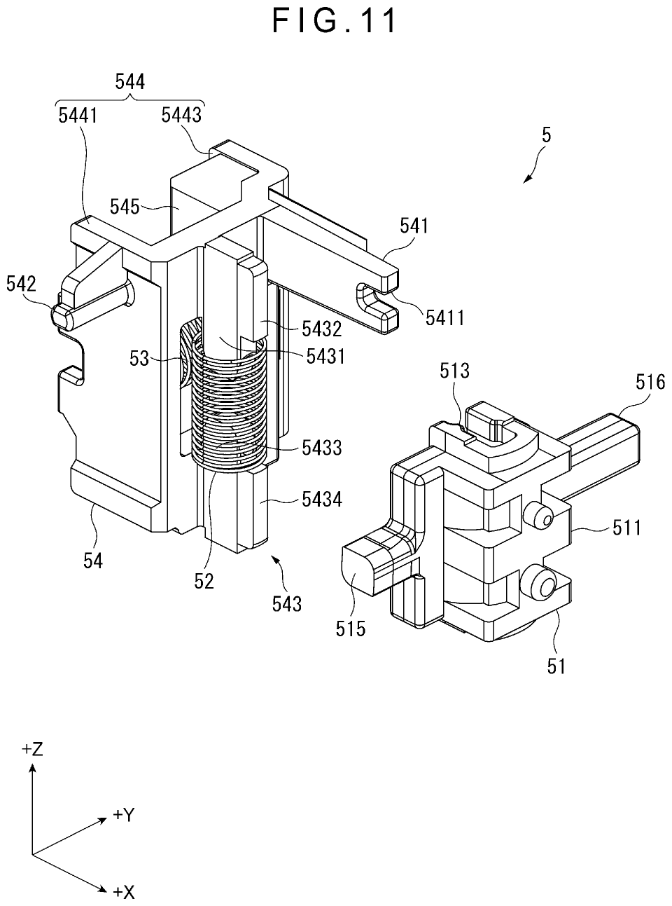

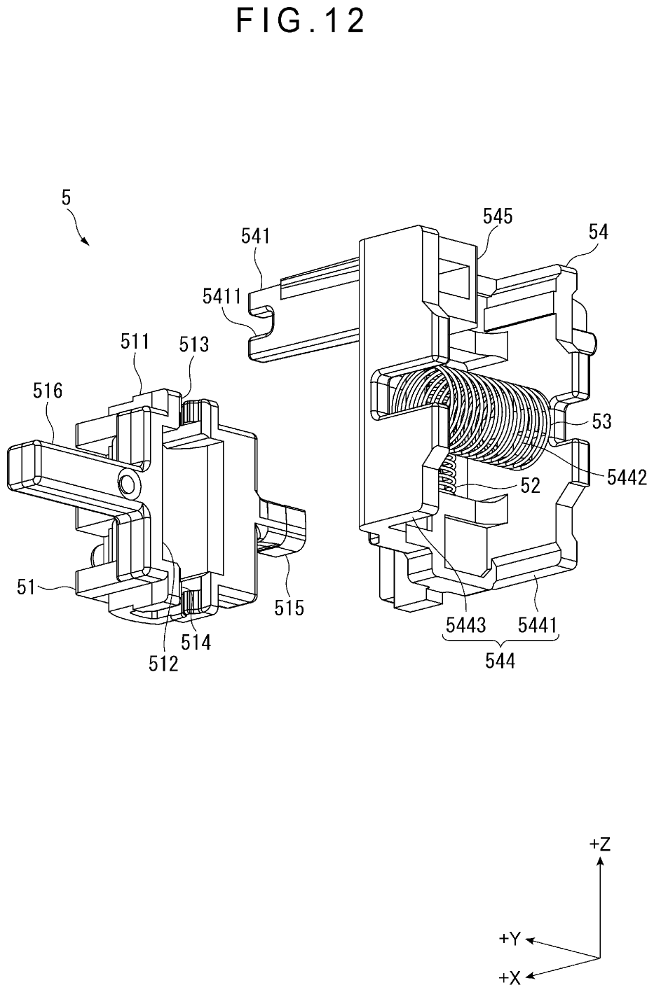

FIG. 11 is an exploded perspective view of the restriction switching mechanism 5 viewed from the +X direction and the −Y direction. FIG. 12 is an exploded perspective view of the restriction switching mechanism 5 viewed from the −X direction and the +Y direction. In FIGS. 11 and 12, illustrations of the switching member 55 and the third biasing member 56 are omitted.

The contact piece 51 is provided to be accessible to the rotator 42. The contact piece 51 comes into contact with the restricting portions 471 and 481 to restrict the rotation of the rotator 42. The contact piece 51 moves relatively in the ±D directions with respect to the rotator 42 along the movement paths RT1 and RT2, in association with the rotation of the rotator 42. Further, the contact piece 51 moves in the ±Z directions along the movement paths RT1 and RT2, in association with the rotation of the rotator 42. The +Z direction and the −Z direction are each a direction along the rotation axis Rx.

As illustrated in FIGS. 11 and 12, the contact piece 51 has a substantially cross shape as viewed from the +X direction. The contact piece 51 includes a contact piece body 511, the contact portion 515, and a protrusion 516.

The contact piece body 511 has a substantially rectangular shape as viewed from the +X direction or the −X direction. As illustrated in FIG. 12, the contact piece body 511 includes an arrangement portion 512 having a substantially rectangular shape that is long in the +Y direction, and to-be-inserted portions 513 and 514 provided continuously with the arrangement portion 512.

The arrangement portion 512 is a recess that is open in the −X direction. When the contact piece 51 and the holding member 54 are combined, the first biasing member 52 included in the holding member 54 is disposed inside the arrangement portion 512.

The to-be-inserted portion 513 is provided in the +Z direction with respect to the arrangement portion 512. The to-be-inserted portion 513 is open in the −X direction and also in the +Z direction, and is provided continuously with the arrangement portion 512. Into the to-be-inserted portion 513, a first locking portion 5432 of the holding member 54 is to be inserted.

The to-be-inserted portion 514 is provided in the −Z direction with respect to the arrangement portion 512. The to-be-inserted portion 514 is open in the −X direction and also in the −Z direction, and is provided continuously with the arrangement portion 512. Into the to-be-inserted portion 514, a second locking portion 5434 of the holding member 54 is to be inserted.

The contact portion 515 is a substantially quadrangular prism-shaped part protruding from the contact piece body 511 in the −Y direction. The contact portion 515 is inserted through the guide hole 343 (see FIG. 5) provided in the casing 3 and comes into contact with the outer circumferential surface 45A of the rotator 42. That is, an end surface in the −Y direction of the contact portion 515 is a contact surface, in the contact piece 51, that is accessible to the outer circumferential surface 45A.

The protrusion 516 is a substantially quadrangular prism-shaped part protruding from the contact piece body 511 in the +Y direction. The protrusion 516 is inserted through the guide 344 (see FIG. 5) provided in the casing 3 along the +Y direction. The contact portion 515 is inserted through the guide hole 343 and the protrusion 516 is inserted through the guide 344, which restricts the contact piece 51 from rotating together with the rotator 42, and moves the contact piece 51 in the +Z direction or the −Z direction in association with the rotation of the rotator 42.

### Configuration of First Biasing Member

As illustrated in FIG. 11, the first biasing member 52 is provided in the holding member 54. The first biasing member 52 biases the contact piece 51 in the +Z direction and the −Z direction to maintain the contact piece 51 at the same position as the second position in the +Z direction. More specifically, if the contact portion 515 is located in the +Z direction relative to the recess 46, the first biasing member 52 biases the contact piece 51 in the −Z direction. If the contact portion 515 is located in the −Z direction relative to the recess 46, the first biasing member 52 biases the contact piece 51 in the +Z direction. That is, the first biasing member 52 biases the contact piece 51 in the −Z direction that is a direction from the first position toward the second position in the counterclockwise-side range, and also biases the contact piece 51 in the +Z direction that is a direction from the first position toward the second position in the clockwise-side range.

In the exemplary embodiment, the first biasing member 52 includes a compression coil spring.

### Configuration of Second Biasing Member

As illustrated in FIG. 12, the second biasing member 53 is provided in the holding member 54. The second biasing member 53 biases the contact piece 51 in the −Y direction via the holding member 54. That is, the second biasing member 53 biases the contact piece 51 in a direction toward the rotation axis Rx of the rotator 42 via the holding member 54.

In the exemplary embodiment, the second biasing member 53 includes a compression coil spring. An end in the +Y direction of the second biasing member 53 is held by the holding portion 341 (see FIG. 6) of the casing 3, and an end in the −Y direction of the second biasing member 53 is held by a second holding portion 544 of the holding member 54.

### Configuration of Holding Member

The holding member 54 holds the first biasing member 52 and the second biasing member 53, and causes the biasing force of the first biasing member 52 and the biasing force of the second biasing member 53 to act on the contact piece 51. Specifically, the holding member 54 maintains a position of the contact piece 51 in such a manner that the contact portion 515 is disposed at the same position as the recess 46 in the +Z direction owing to the biasing force of the first biasing member 52. Further, the holding member 54 maintains a state in which the contact portion 515 is in contact with the outer circumferential surface 45A owing to the biasing force of the second biasing member 53.

As illustrated in FIGS. 11 and 12, the holding member 54 includes a first protrusion 541, a second protrusion 542, a first holding portion 543, the second holding portion 544, and a to-be-pressed portion 545.

The first protrusion 541 protrudes in the +X direction from an end in the +Z direction of the holding member 54. On an end surface in the +X direction of the first protrusion 541, a recess 5411 recessed in the −X direction is provided. In the recess 5411, an unillustrated protrusion of the casing 3 is inserted, whereby sliding of the holding member 54 in the ±Y directions is guided, and the holding member 54 is prevented from moving in the ±Z directions.

The second protrusion 542 protrudes in the −Y direction from the end in the +Z direction of the holding member 54. The second protrusion 542 is inserted into an unillustrated recess of the casing 3.

The first holding portion 543 holds the first biasing member 52. As illustrated in FIG. 11, the first holding portion 543 includes a first holding piece 5431, the first locking portion 5432, a second holding piece 5433, and the second locking portion 5434.

The first holding piece 5431 and the second holding piece 5433 are provided in a part in the +X direction of the holding member 54, and are separated from each other in the +Z direction. The first holding piece 5431 is separated in the +Z direction from the second holding piece 5433.

The first holding piece 5431 is inserted in an end in the +Z direction of the first biasing member 52, and the second holding piece 5433 is inserted in an end in the −Z direction of the first biasing member 52.

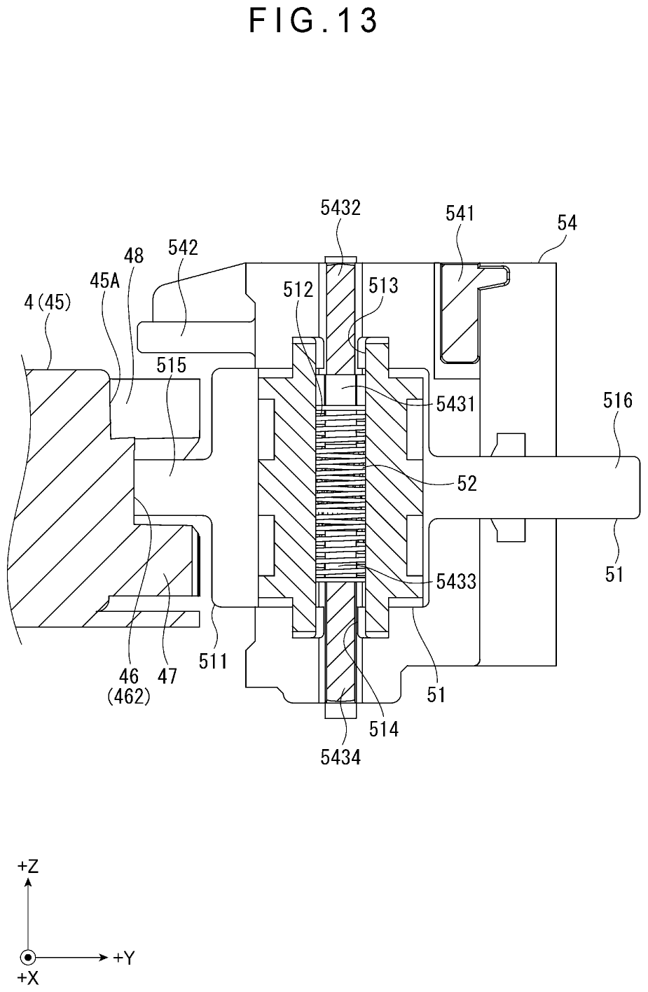

FIG. 13 is a diagram illustrating a cross section along a YZ plane of the rotator 42 and the restriction switching mechanism 5.

As illustrated in FIG. 11, the first locking portion 5432 protrudes in the +X direction from a part in the +Z direction of the first holding piece 5431. The second locking portion 5434 protrudes in the +X direction from a part in the −Z direction of the second holding piece 5433.

As illustrated in FIG. 13, when the contact piece 51 is moved in the +Z direction, the end in the +Z direction of the first biasing member 52 abuts against a surface in the −Z direction of the first locking portion 5432, and the first locking portion 5432 locks the first biasing member 52. This restricts the first biasing member 52 from moving together with the contact piece 51 in the +Z direction, and causes the first biasing member 52 to generate the biasing force to bias the contact piece 51 in the −Z direction. That is, when the contact piece 51 moves in the +Z direction, the first biasing member 52 biases the contact piece 51 in the −Z direction.

When contact piece 51 is moved in the −Z direction, the end in the −Z direction of the first biasing member 52 abuts against a surface in the +Z direction of the second locking portion 5434, and the second locking portion 5434 locks the first biasing member 52. This restricts the first biasing member 52 from moving together with the contact piece 51 in the −Z direction, and causes the first biasing member 52 to generate the biasing force to bias the contact piece 51 in the +Z direction. That is, when the contact piece 51 moves in the −Z direction, the first biasing member 52 biases the contact piece 51 in the +Z direction.

As illustrated in FIG. 12, the second holding portion 544 holds the second biasing member 53. The second holding portion 544 includes a first wall portion 5441 and a second wall portion 5443 opposed to each other in the +Y direction.

The first wall portion 5441 includes an insertion portion 5442 to be inserted into an end in the −Y direction of the second biasing member 53 disposed along the +Y direction.

The second wall portion 5443 is provided in the +Y direction with respect to the first wall portion 5441. The holding portion 341 (see FIG. 6) of the casing 3 is disposed between the first wall portion 5441 and the second wall portion 5443 in the +Y direction. As described above, an end in the −Y direction of the holding portion 341 locks the end in the +Y direction of the second biasing member 53.

In this manner, the end in the −Y direction of the second biasing member 53 is locked to the first wall portion 5441 in a state in which the end in the +Y direction of the second biasing member 53 is in contact with the casing 3. Thus, the holding member 54 and the contact piece 51 are biased in the −Y direction by the second biasing member 53. That is, the holding member 54 and the contact piece 51 are biased by the second biasing member 53 toward the rotation axis Rx of the rotator 42.

As illustrated in FIGS. 10 to 12, the to-be-pressed portion 545 is provided on a surface in the −Y direction of the second wall portion 5443. The to-be-pressed portion 545 is pressed in the +Y direction by the switching member 55 rotated counterclockwise as viewed from the +Z direction. At this time, the holding member 54 is moved in the +Y direction against the biasing force of the second biasing member 53, and thus the contact piece 51 is moved in the +Y direction. As a result, it is possible to cause the contact piece 51 to be separated from the rotator 42 to such an extent that the contact portion 515 does not come into contact with the rotator 42, and to switch the state of the rotator 42 to the unrestricted state in which the rotation of the rotator 42 is not restricted at the reference position.

### Configuration of Switching Member

The switching member 55 switches the position of the contact piece 51 in association with sliding of a slide member 72 to be described later, between: a position at which the contact piece 51 is accessible to the rotator 42 of the rotary operator 2; and a position at which the contact piece 51 is not accessible to the rotator 42 of the rotary operator 2. As illustrated in FIGS. 9 and 10, the switching member 55 is a lever supported by the lever support 35 (see FIGS. 5 and 6) of the casing 3 in such a manner as to be rotatable clockwise and counterclockwise as viewed from the +Z direction, and rotates in association with the sliding of the slide member 72 to switch the position of the contact piece 51. The switching member 55 includes a pressing portion 551, an engagement portion 552, and a locking portion 553.

The pressing portion 551 presses the to-be-pressed portion 545 in the +Y direction to separate the contact piece 51 from the rotator 42 when the switching member 55 rotates counterclockwise as viewed from the +Z direction.

The engagement portion 552 engages with the slide member 72 of the state switching mechanism 7 to be described below. The engagement portion 552 is provided on an end of the switching member 55 opposite to an end on which the pressing portion 551 is provided, and is a cylindrical boss that protrudes in the −Z direction.

The locking portion 553 locks an end of the third biasing member 56.

### Configuration of Third Biasing Member

The third biasing member 56 is the torsion coil spring provided in the lever support 35 (see FIGS. 5 and 6). One end of the third biasing member 56 is locked by the locking portion 36 (see FIGS. 5 and 6) and the other end of the third biasing member 56 is locked to the locking portion 553 of the switching member 55.

The third biasing member 56 biases the switching member 55 counterclockwise as viewed from the +Z direction. The switching member 55 rotated counterclockwise presses the holding member 54 in the +Y direction, and thus the contact piece 51 is separated in the +Y direction from the rotator 42, as described above. That is, the third biasing member 56 biases the contact piece 51 in the +Y direction away from the rotator 42.

In contrast, when the slide member 72 to be described later of the state switching mechanism 7 is slid in the +Y direction, the slide member 72 causes the switching member 55 to rotate clockwise as viewed from the +Z direction against the biasing force of the third biasing member 56. Thus, the pressing portion 551 is separated from the to-be-pressed portion 545, the holding member 54 and the contact piece 51 become movable in the −Y direction owing to the biasing force of the second biasing member 53, and the contact portion 515 comes into contact with the cylindrical portion 45 of the rotator 42.

### Restriction on Rotation of Rotator by Contact Piece

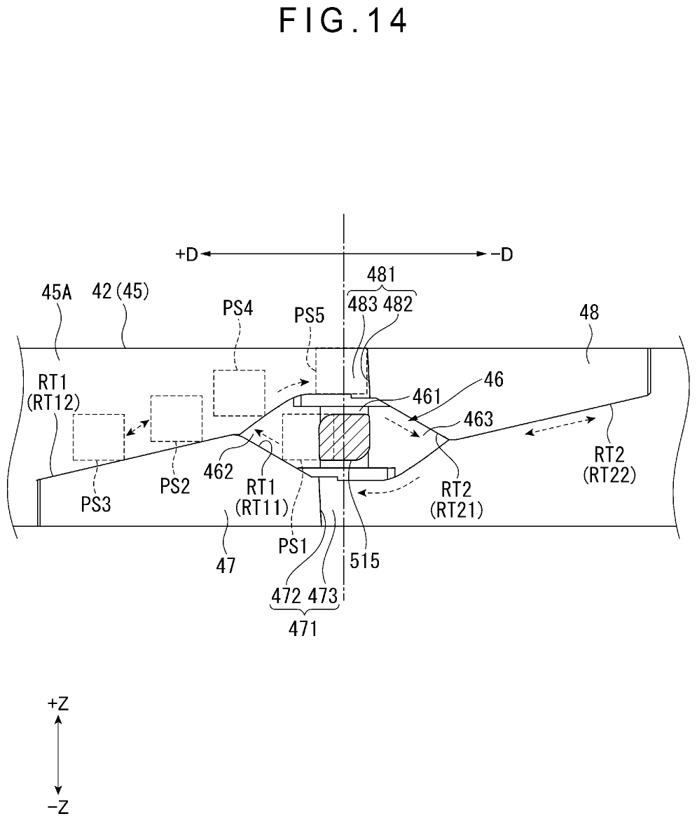

FIG. 14 is a schematic diagram illustrating a position of the contact portion 515 when the rotator 42 is rotated in the counterclockwise-side range.

When the rotator 42 is located at the reference position, the contact piece 51 is disposed at the second position where the contact portion 515 is disposed on the bottom 461. When the rotator 42 is rotated in the −D direction from the state where the rotator 42 is disposed at the reference position, the contact portion 515 reaches the first path RT11 from the bottom 461 via the inclined portion 462, as indicated by a position PS1 in FIG. 14.

When the contact portion 515 is located on the inclined portion 462 or the first path RT11, and if the rotator 42 is rotated in the +D direction and the contact portion 515 moves relatively in the −D direction, the contact portion 515 returns to the bottom 461.

If the rotator 42 is rotated further in the −D direction in a state in which the contact portion 515 is disposed on the first path RT11, the contact portion 515 reaches the second path RT12 from the first path RT11, as indicated by a position PS2 in FIG. 14, for example. At this time, the biasing force in the −Z direction applied by the first biasing member 52 acts on the contact piece 51, and the contact portion 515 is pressed in the −Z direction with respect to the path forming portion 47.

If the rotator 42 is rotated in the −D direction in a state in which the contact portion 515 is disposed on the second path RT12, the contact portion 515 moves relatively in the +D direction with respect to the rotator 42 along the second path RT12, as indicated by a position PS3 in FIG. 14, for example. Similarly, if the rotator 42 is rotated in the +D direction in the state in which the contact portion 515 is disposed on the second path RT12, the contact portion 515 is moved relatively in the −D direction with respect to the rotator 42 along the second path RT12.

At this time, if the contact portion 515 is disposed in the +Z direction relative to the bottom 461, the first biasing member 52 applies the biasing force in the −Z direction to the contact portion 515. That is, if the contact piece 51 is disposed in the +Z direction relative to the second reference position, the first biasing member 52 applies the biasing force in the −Z direction to the contact piece 51.

In contrast, if the contact portion 515 is located in the −Z direction relative to the bottom 461, the first biasing member 52 applies the biasing force in the +Z direction to the contact portion 515. That is, if the contact piece 51 is disposed in the −Z direction relative to the second reference position, the first biasing member 52 applies the biasing force in the +Z direction to the contact piece 51.

It is to be noted that, although not illustrated, when the contact portion 515 reaches the rotation limit in the +D direction, the contact portion 515 is disposed in the +D direction with respect to the path forming portion 47. A position of the contact piece 51 in the +Z direction in this case is the same as the second position. Specifically, if the contact portion 515 is moved in the +D direction along the second path RT12, and the position in the +Z direction of the contact portion 515 reaches a position that is the same as the position of the contact portion 515 in the case of the second position, the contact portion 515 remains to be separated from the path forming portion 47 and is moved in the +D direction in association with the rotation of the rotator 42 in the −D direction. That is, a path between the position at which the contact portion 515 is separated from the path forming portion 47 and the rotation limit in the +D direction of the contact portion 515 on the second path RT12 is along the circumferential direction about the rotation axis Rx.

Here, the second path RT12 is provided at a position closer to the rotation axis Rx than the first path RT11. Accordingly, when reaching the second path RT12 from the first path RT11, the contact piece 51 moves in the −Y direction that is slightly on a side of the rotation axis Rx owing to the biasing force of the second biasing member 53. Thus, when the rotator 42 is rotated in the +D direction in a state in which the contact portion 515 is disposed on the second path RT12, the movement of the contact piece 51 from the second path RT12 to the first path RT11 is restricted, and the movement of the contact piece 51 along the second path RT12 is allowed. Accordingly, if the rotator 42 is rotated in the +D direction, the contact portion 515 reaches a position PS4 in FIG. 14, for example.

If the rotator 42 is rotated in the +D direction in a state in which the contact portion 515 is disposed on the second path RT12 and reaches the guide surface 483, the contact piece 51 is moved by the guide surface 483 in the +Y direction separating from the rotator 42.

If the rotator 42 is further rotated in the +D direction to reach the reference position, the contact portion 515 comes into contact with the restricting surface 482, as indicated by a position PS5 in FIG. 14. The position PS5 at which the contact portion 515 is in contact with the restricting portion 481 is the first position in the counterclockwise range described above. This restricts the relative movement in the −D direction of the contact portion 515, and restricts the rotation of the rotator 42 in the +D direction.

In a state in which the contact piece 51 is disposed at the first position, the end surface in the −Y direction of the contact portion 515 is disposed in the +Y direction relative to the path forming portion 47. Thus, the contact piece 51 is movable beyond the path forming portion 47 in a direction from the first position toward the second position, i.e., in the −Z direction. Accordingly, when the user releases his or her hand from the dial 43, for example, to reduce the rotating force in the +D direction with respect to the rotator 42, the contact portion 515 moves in the −Z direction owing to the biasing force of the first biasing member 52 and returns to the bottom 461. That is, the contact piece 51 returns to the second position.

As a result, the contact portion 515 is movable relatively in the tD directions with respect to the rotator 42, and the rotator 42 is rotatable in the ±D directions.

It should be noted that when the rotator 42 is rotated in the +D direction in the state in which the contact piece 51 is disposed at the second position where the contact portion 515 is located on the bottom 461, the contact portion 515 moves relatively in the −D direction with respect to the rotator 42 along the inclined portion 463, and moves relatively with respect to the rotator 42 along the first path RT21 and the second path RT22. When the rotator 42 is rotated in the −D direction and the contact portion 515 moved along the second path RT22 and the guide surface 473 reaches the restricting portion 471, the restricting portion 471 restricts the rotation in the −D direction of the rotator 42. The position of the contact piece 51 when the contact portion 515 comes into contact with the restricting portion 471 is the first position in the clockwise-side range described above.

If the rotating force in the −D direction applied to the rotator 42 is reduced in this state, the contact portion 515 moves in the +Z direction owing to the biasing force of the first biasing member 52 and the contact piece 51 returns to the second position.

As a result, the contact portion 515 is movable relatively in the ±D directions with respect to the rotator 42, and the rotator 42 is rotatable in the ±D directions.

Here, the contact piece 51 is moved in the +Y direction as the contact piece 51 proceeds in the +D direction along the guide surface 473. Accordingly, when the contact piece 51 is disposed at the first position that is in contact with the restricting portion 471, the contact piece 51 is movable beyond the path forming portion 47 from the first position to the second position.

Similarly, the contact piece 51 is moved in the +Y direction as the contact piece 51 proceeds in the −D direction along the guide surface 483. Accordingly, when the contact piece 51 is disposed at the first position that is in contact with the restricting portion 481, the contact piece 51 is movable beyond the path forming portion 48 from the first position to the second position.

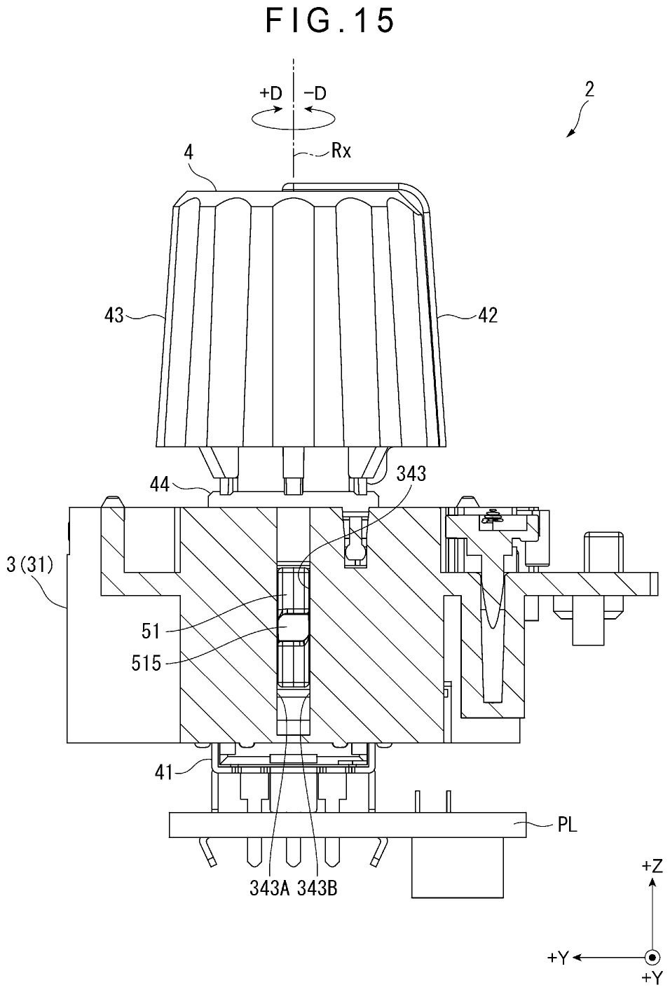

FIG. 15 is a view of a cross section along an XZ plane of the rotary operator 2 taken along a position of the contact portion 515 that is inserted through the guide hole 343 in the −Y direction. In other words, FIG. 15 is a view of a cross section of the rotary operator 2 taken along a line XV-XV indicated in FIG. 5. It is to be noted that, in FIG. 15, the contact piece 51 is disposed at the second position.

However, upon the rotation in the +D direction of the rotator 42 in the counterclockwise-side range, the contact piece 51 is pushed out in the +Y direction by the guide surface 473, and is simultaneously pressed against an inner surface 343A provided in the +X direction of the guide hole 343 as illustrated in FIG. 15. Further, upon the rotation in the −D direction of the rotator 42 in the clockwise-side range, the contact piece 51 is pushed out in the +Y direction by the guide surface 483, and is simultaneously pressed against an inner surface 3438 provided in the −X direction of the guide hole 343. The contact portion 515 is thus in a state of being caught between the guide surface 473 and the inner surface 343B, or in a state of being caught between the guide surface 483 and the inner surface 343A. In this case, it is difficult for the contact piece 51 to move from the first position to the second position.

Whether or not the contact piece 51 moves to the second position while being pushed out in the +Y direction by the guide surface 473 or the guide surface 483 depends on balance between the biasing force of the first biasing member 52 and the biasing force of the second biasing member 53.

For example, setting the biasing force of the first biasing member 52 to be lower than a first threshold and the biasing force of the second biasing member 53 to be higher than a second threshold makes it possible to configure the rotary operator 2 in such a manner that no movement toward the second position is performed during the rotation of the rotator 42, i.e., when a torque that makes the rotator 42 rotatable is applied to the dial 43.

Further, for example, setting the biasing force of the first biasing member 52 to be higher than the first threshold and the biasing force of the second biasing member 53 to be lower than the second threshold makes it possible to configure the rotary operator 2 in such a manner that the contact piece 51 reaches the second position prior to the contact piece 51 reaching the restricting surface 472 or the restricting surface 482, unless the rotator 42 is rotated at or above a predetermined rotation rate. In this case, it is possible to configure the rotary operator 2 in such a manner that: the restricting surface 472 does not restrict the movement of the contact piece 51 in the +D direction, i.e., the rotation of the rotator 42 in the −D direction; and the restricting surface 482 does not restrict the movement of the contact piece 51 in the −D direction, i.e., the rotation of the rotator 42 in the +D direction.

### Configuration of Operational-Feeling Switching Mechanism

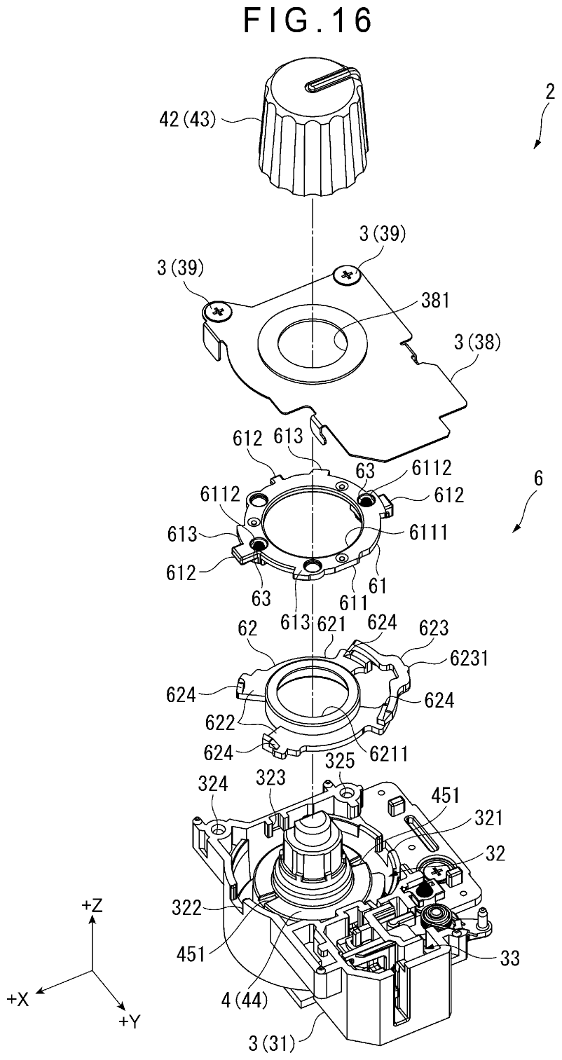

FIGS. 16 and 17 are each an exploded perspective view of the operator body 4 and the operational-feeling switching mechanism 6. Specifically, FIG. 16 is the exploded perspective view of the operator body 4 and the operational-feeling switching mechanism 6 viewed from the +Z direction, and FIG. 17 is the exploded perspective view of the operator body 4 and the operational-feeling switching mechanism 6 viewed from the −Z direction.

The operational-feeling switching mechanism 6 switches the operational feelings of the rotary operator 2 in response to the switching operation on the state switching mechanism 7 to be described later, along with the switching of the operation modes performed by the state switching mechanism 7. In the exemplary embodiment, the operational feelings are clicking feelings, and the operational-feeling switching mechanism 6 performs switching between a state in which a clicking feeling occurs when the rotator 42 is rotated and a state in which no clicking feeling occurs when the rotator 42 is rotated.

The operational-feeling switching mechanism 6 is provided between the cover 38 and the cylindrical portion 45 of the rotator 42 in the first arrangement portion 32 of the casing 3. As illustrated in FIGS. 16 and 17, the operational-feeling switching mechanism 6 includes the click plate 61, the movement base 62, and a biasing member 63.

### Configuration of Click Plate

The click plate 61 is provided in the +Z direction with respect to the cylindrical portion 45, and is moved by the movement base 62 in the −Z direction toward the cylindrical portion 45 of the rotator 42 or in the +Z direction away from the cylindrical portion 45. The click plate 61 corresponds to an engagement member, and is engageable with the cylindrical portion 45 when moved in the −Z direction. The click plate 61 includes a plate body 611, the to-be-guided portion 612, an engagement portion 613, and the protrusion 614.

The plate body 611 has a ring shape. The plate body 611 has an opening 6111 having a circular shape into which a portion in the +Z direction of the rotating body 44 is to be inserted. The plate body 611 has a surface in the +Z direction provided with two arrangement portions 6112 that are recessed in the −Z direction.

The two arrangement portions 6112 are provided at positions sandwiching the center of the click plate 61 as viewed from the +Z direction. The biasing member 63 is provided inside each of the arrangement portions 6112.

The to-be-guided portion 612 is a part that protrudes radially outward from an outer periphery of the plate body 611. The plate body 611 is provided with three to-be-guided portions 612. The to-be-guided portions 612 are each disposed in corresponding one of the guides 321 to 323 provided in the casing 3 to restrict rotation of the click plate 61 about the rotation axis Rx and to guide the movement in the ±Z directions.

As with the to-be-guided portion 612, the engagement portion 613 is a part that protrudes radially outward from the outer periphery of the plate body 611. The plate body 611 is provided with three engagement portions 613. Each of the engagement portions 613 engages with an inclined portion 624 of the movement base 62.

As illustrated in FIG. 17, the protrusion 614 is provided in each of two to-be-guided portions 612 that are provided at both ends in the +X direction of the plate body 611, out of the three to-be-guided portions 612. Each of the protrusions 614 protrudes in a substantially truncated quadrangular pyramid shape in the −Z direction from a surface in the −Z direction of the to-be-guided portion 612. That is, the protrusion 614 has an inclined surface facing the +Y direction and an inclined surface facing the −Y direction. In other words, the protrusion 614 has an inclined surface facing the +D direction and an inclined surface facing the −D direction.

The protrusion 614 fits into the fitting portion 451 when the rotator 42 is rotated to cause the clicking feeling to occur. It is to be noted that a position of the fitting portion 451 in the rotator 42 and a position of the protrusion 614 in the click plate 61 are defined in such a manner that the clicking feeling occurs when, for example, the rotator 42 is disposed at a first reference position.

The click plate 61 is movable in the ±Z directions. The protrusion 614 is thus separated from the fitting portion 451 if the rotator 42 is further rotated in the state in which the protrusion 614 is fitted into the fitting portion 451.

### Configuration of Movement Base

The movement base 62 is provided to be rotatable about the rotation axis Rx of the rotator 42. The movement base 62 engages with the slide member 72 of the state switching mechanism 7 to be described later, and moves the click plate 61 in the ±Z directions in association with movement in the ±Y directions of the slide member 72. That is, the movement base 62 is a drive member that moves the click plate 61 closer to or away from the fitting portion 451 of the rotator 42 in association with the sliding of the slide member 72. As illustrated in FIGS. 16 and 17, the movement base 62 includes a base body 621, two extending portions 622, a connecting portion 623, and the inclined portion 624.

The base body 621 has a ring shape. The base body 621 has an opening 6211 having a circular shape into which a portion in the +Z direction of the rotating body 44 is to be inserted.

The two extending portions 622 extend radially outward from a periphery of the base body 621 as viewed from the +Z direction and in opposite directions to each other. Specifically, one extending portion 622 out of the two extending portions 622 extends in the +Y direction and the other extending portion 622 extends in the −Y direction.

The connecting portion 623 couples ends in the −X direction of the respective extending portions 622 to each other. The connecting portion 623 includes an engagement portion 6231 that is provided on an end in the −X direction and is to be engaged with the slide member 72. That is, the operational-feeling switching mechanism 6 includes the engagement portion 6231 that engages with the slide member 72. The engagement portion 6231 has a cylindrical shape protruding in the −Z direction from the connecting portion 623.

As illustrated in FIG. 16, the inclined portion 624 is provided in each of ends in the +X direction and ends in the −X direction of the respective extending portions 622. That is, the movement base 62 includes four inclined portions 624. Each of the inclined portions 624 is inclined with respect to the circumferential direction about the rotation axis of the movement base 62. More specifically, the inclined portion 624 is inclined in such a manner as to face the +Z direction and the counterclockwise direction about the rotation axis Rx as viewed from the +Z direction. The inclined portion 624 pushes up in the +Z direction the engagement portion 613 and the to-be-guided portion 612 in the −X direction in association with the counterclockwise rotation as viewed from the +Z direction of the movement base 62, and thus separates the click plate 61 from the cylindrical portion 45. Accordingly, even if the rotator 42 is rotated, the protrusion 614 is not fitted to the fitting portion 451, and no clicking feeling occurs.

### Configuration of Biasing Member

The biasing member 63 biases the click plate 61 in the −Z direction. As illustrated in FIG. 16, the biasing member 63 is provided in the corresponding arrangement portion 6112 and is disposed between the cover 38 and the click plate 61. That is, the operational-feeling switching mechanism 6 includes two biasing members 63. An end in the +Z direction of each of the biasing members 63 is in contact with a surface in the −Z direction of the cover 38 and an end in the −Z direction of each of the biasing members 63 is in contact with the click plate 61.

### Action of Operational-Feeling Switching Mechanism

When the click plate 61 is not moved in the +Z direction by the movement base 62, the click plate 61 is biased by the biasing member 63 in the direction toward the cylindrical portion 45 of the rotating body 44, and is disposed at a position where the protrusion 614 is fittable in the fitting portion 451 in the +Z direction. That is, the click plate 61 is disposed at a position that makes it possible to cause the clicking feeling to occur.

In contrast, when the movement base 62 is rotated counterclockwise as viewed from the +Z direction and the click plate 61 is moved in the +Z direction against the biasing force of the biasing member 63, the protrusion 614 is separated in the +Z direction from the fitting portion 451. This causes the protrusion 614 to be disposed at a position that makes it not possible to fit in the fitting portion 451 in the +Z direction. That is, the click plate 61 is disposed at a position that makes it not possible to cause the clicking feeling to occur.

Such rotation of the movement base 62 is performed by the sliding of the slide member 72 with which the movement base 62 engages.

### Configuration of State Switching Mechanism

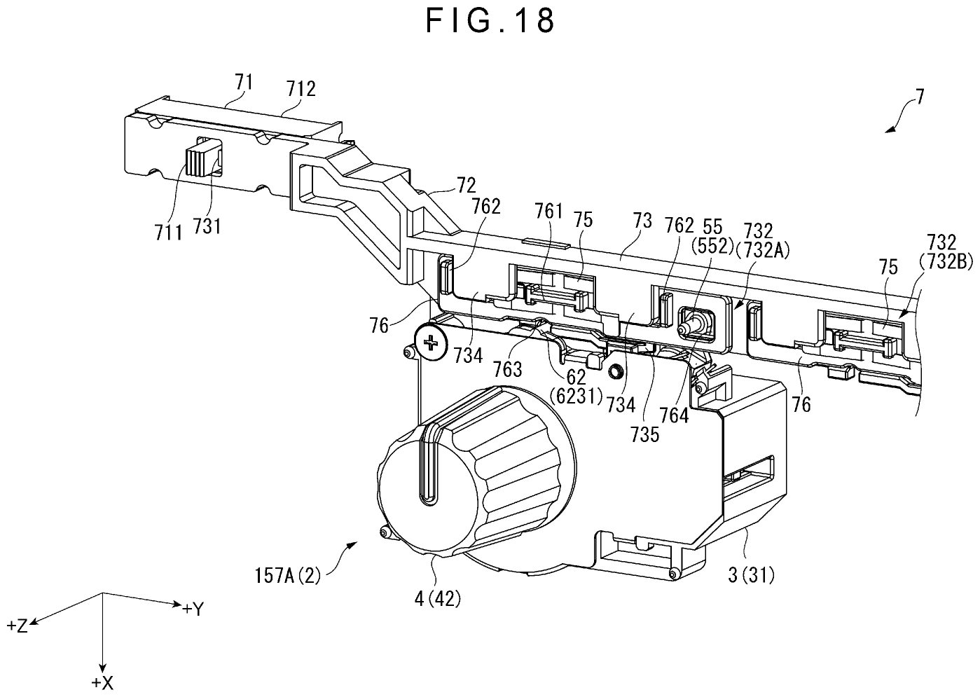

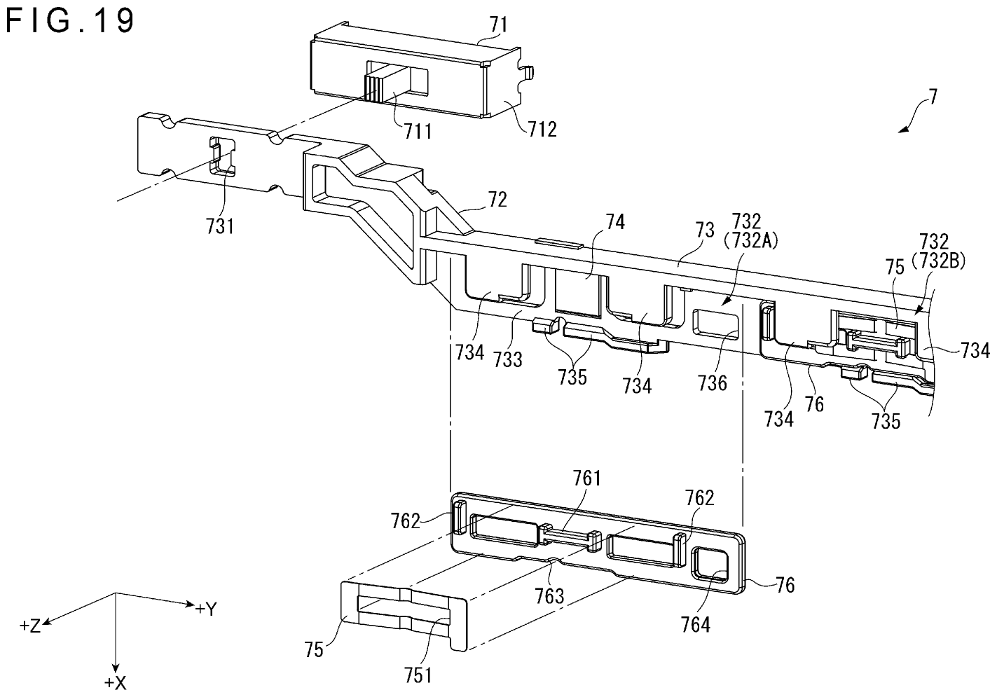

FIG. 18 is a perspective view of a portion of the state switching mechanism 7 and one rotary operator 2. More specifically, FIG. 18 is the perspective view illustrating a portion of the state switching mechanism 7 and the rotary operator 2 that configures the effect adjuster 157A. FIG. 19 is an exploded perspective view of a portion of the state switching mechanism 7.

As described above, the state switching mechanism 7 switches the operation modes and the operational feelings of the rotary operator 2 as described above. As illustrated in FIGS. 2, 18, and 19, the state switching mechanism 7 includes a slide switch 71 and the slide member 72.

### Configuration of Slide Switch

As illustrated in FIGS. 18 and 19, the slide switch 71 includes the slide operator 711, and a holder 712 that holds the slide operator 711. The slide switch 71 switches the operation modes of the rotary operator 2 in accordance with the position of the slide operator 711.

The slide operator 711 is exposed on the microphone adjuster 12 (see FIG. 1) on the top surface 11A of the casing 11. The slide operator 711 is provided to be slidable in the +Y direction in the holder 712. The slide operator 711 is allocatable at three positions along the +Y direction. That is, the slide operator 711 is allocatable at one switching position out of a first switching position, a second switching position that is a position in the +Y direction with respect to the first switching position, and a third switching position that is a position in the +Y direction with respect to the second switching position.

The holder 712 is fixed in the casing 11. The holder 712 outputs an operation signal corresponding to the position of the slide operator 711 to a controller (not illustrated) that controls the acoustic device 1, and switches the operation modes of the rotary operator 2.

Setting of the operation modes in accordance with the disposition position of the slide operator 711 will be described in detail later.

### Configuration of Slide Member

The slide member 72 is provided in the casing 11 to be slidable in response to a slide operation on the slide operator 711. That is, the slide member 72 slides with the slide operator 711 in the same direction as a direction in which the slide operator 711 slides. The slide member 72 includes a first slide member 73, an elastic member 74, a biasing member 75, and a second slide member 76.

The first slide member 73 engages with the slide operator 711 and slides in the ±Y directions with the slide operator 711. The first slide member 73 has one opening 731 as illustrated in FIGS. 2, 18, and 19, and includes a holding portion 732 as illustrated in FIG. 2.

The slide operator 711 is inserted from the −Z direction into the opening 731. An inner diameter of the opening 731 substantially matches the outer diameter of the slide operator 711. The slide operator 711 is thus exposed from the opening 731 in the +Z direction. Sliding in the ±Y directions the slide operator 711 exposed on the top surface 11A of the casing 11 causes the first slide member 73 to slide in the same direction as the slide direction of the slide operator 711.

The holding portion 732 holds the elastic member 74, the biasing member 75, and the second slide member 76. The number of each of the holding portions 732, the elastic members 74, the biasing members 75, and the second slide members 76 is determined in accordance with the number of the rotary operators 2. As illustrated in FIG. 2, the holding portion 732 includes a holding portion 732A corresponding to the rotary operator 2 that configures the effect adjuster 157A, a holding portion 732B corresponding to the rotary operator 2 that configures the effect adjuster 157B, a holding portion 732C corresponding to the rotary operator 2 that configures the effect adjuster 157C, and a holding portion 732D corresponding to the rotary operator 2 that configures the effect adjuster 157D.

As illustrated in FIGS. 18 and 19, the holding portion 732A includes an arrangement portion 733, two clamp pieces 734, two engagement pieces 735, and an opening 736.

The arrangement portion 733 is a wall along an XY plane. On the arrangement portion 733, the elastic member 74 is fixed, and in addition, the biasing member 75 and the second slide member 76 are disposed.

The two clamp pieces 734 are provided at respective positions opposed to the arrangement portion 733 in the +Z direction. The two clamp pieces 734 clamp the biasing member 75 and the second slide member 76 disposed on the arrangement portion 733 between the arrangement portion 733 and the two clamp pieces 734.

The two engagement pieces 735 project in the +Z direction from an end in the +X direction of the arrangement portion 733. The two engagement pieces 735 restrict the biasing member 75 and the second slide member 76 disposed on the arrangement portion 733 from sliding in the +X direction. The engagement portion 6231 of the movement base 62 is disposed between the two engagement pieces 735. Thus, when the slide member 72 is slid in the −Y direction, the slide member 72 causes the movement base 62 to rotate counterclockwise as viewed from the +Z direction, and when the slide member 72 is slid in the +Y direction, the slide member 72 causes the movement base 62 to rotate clockwise as viewed from the +Z direction.

The opening 736 is an opening having a rectangular shape that is long in the +Y direction. The engagement portion 552 of the switching member 55 is inserted into the opening 736.

It is to be noted that the holding portions 732B, 732C, and 732D each have the same configuration as that of the holding portion 732A, and thus the descriptions thereof are omitted.

### Configurations of Elastic Member and Biasing Member

As illustrated in FIG. 19, the elastic member 74 is a member that is provided on a surface in the +Z direction of the arrangement portion 733 and fills a gap between the arrangement portion 733 and the second slide member 76 provided on the arrangement portion 733. The elastic member 74 suppresses unintentional sliding of the second slide member 76 along the XY plane.

The biasing member 75 is a member that biases the second slide member 76 toward the first slide member 73. In the exemplary embodiment, a leaf spring is employed as the biasing member 75. The biasing member 75 is disposed between the clamp piece 734 and the arrangement portion 733 to bias the second slide member 76 toward the arrangement portion 733. An opening 751 along the +Y direction is provided in the middle of the biasing member 75 as viewed from the +Z direction, and an insertion portion 761 of the second slide member 76 is inserted into the opening 751.

### Configuration of Second Slide Member

The second slide member 76 is provided on the arrangement portion 733 of the first slide member 73 to be slidable in the ±Y directions that are the slide directions of the first slide member 73. The second slide member 76 causes the switching member 55 of the corresponding rotary operator 2 to rotate. The second slide member 76 is provided to absorb tolerances of components including, without limitation, the restriction switching mechanism 5 and the first slide member 73. The second slide member 76 includes the insertion portion 761, a restricting piece 762, a recess 763, and a through opening 764.

The insertion portion 761 protrudes in the +Z direction from approximately the middle of the second slide member 76 as viewed from the +Z direction. The insertion portion 761 is inserted into the opening 751 of the biasing member 75.

Two restricting pieces 762 are provided on a surface in the +Z direction of the second slide member 76, and the two restricting pieces 762 are separated from each other in the +Y direction. The biasing member 75 is disposed between the two restricting pieces 762, and in addition, the two clamp pieces 734 are sandwiched between the two restricting pieces 762 in the +Y direction. As a result, a slidable range in the +Y direction of the second slide member 76 is defined.

The recess 763 is provided on an end surface in the +X direction of the second slide member 76. The recess 763 is a recess recessed in the −X direction, and is a part for avoiding the engagement portion 6231 of the movement base 62 that engages with the two engagement pieces 735.

The through opening 764 is an opening provided in a part in the +Y direction of the second slide member 76. The through opening 764 passes through the second slide member 76 along the +Z direction. The engagement portion 552 of the switching member 55 is inserted into the through opening 764. When the slide member 72 slides in the −Y direction, an inner surface in the −Y direction out of inner surfaces of the through opening 764 presses the engagement portion 552 in the +Y direction to cause the switching member 55 to rotate clockwise as viewed from the +Z direction.

### Action of State Switching Mechanism

As described above, the slide operator 711 is slid in the ±Y directions and is thereby disposed at one of the first switching position, the second switching position, and the third switching position. Further, the slide member 72 is engaged with the slide operator 711, and thus slides in the ±Y directions together with the slide operator 711.

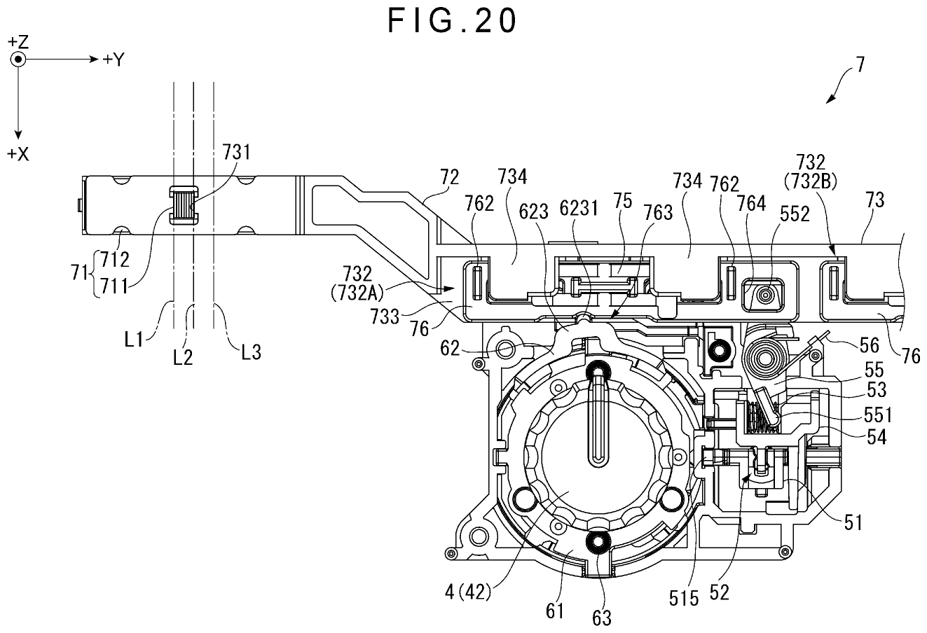

FIG. 20 is a plan view of the state switching mechanism 7 in a state in which the slide operator 711 is disposed at the first switching position. In FIG. 20, a chain line L1 indicates a position of an end in the −Y direction of the slide operator 711 disposed at the first switching position. A chain line L2 indicates a position of the end in the −Y direction of the slide operator 711 disposed at the second switching position. A chain line L3 indicates a position of the end in the −Y direction of the slide operator 711 disposed at the third switching position.

As illustrated in FIG. 20, when an operation of disposing the slide operator 711 at the first switching position is performed, the holder 712 outputs, to the controller, an operation signal for switching the operation mode of the rotary operator 2, and thus the operation mode of the acoustic device 1, to a first mode. The controller to which the signal for switching the operation mode to the first mode is inputted switches the operation mode of the rotary operator 2 to the first mode.

When the slide operator 711 is disposed at the first switching position, the slide member 72 is disposed farthest in the −Y direction in a movable range of the slide member 72.

In this case, the movement base 62 engaged with the slide member 72 causes the click plate 61 of the operational-feeling switching mechanism 6 to be disposed at a position in which the protrusion 614 does not fit into the fitting portion 451 even when the rotator 42 is rotated. In other words, the movement base 62 disposes the click plate 61 at a position where no clicking feeling occurs even when the rotator 42 is rotated.

Further, the holding member 54 and the contact piece 51 are biased by the third biasing member 56, and are disposed at respective positions that are separated in the +Y direction from the rotator 42 by the switching member 55 engaged with the slide member 72. In this state, the contact portion 515 is separated from the rotator 42, and thus the rotation of the rotator 42 that passes the reference position is not restricted by the contact piece 51.

In the exemplary embodiment, the first mode is an operation mode for setting an effect amount of one effect by all rotatable range of the rotator 42 including the reference position. That is, the first mode is a mode in which the effect amount of one effect is set based on the rotation angle of the rotator 42, where the rotation limit in the −D direction of the rotator 42 is set as a minimum value and the rotation limit in the +D direction of the rotator 42 is set as a maximum value. In the first mode, no clicking feeling occurs during rotation operation of the rotator 42.

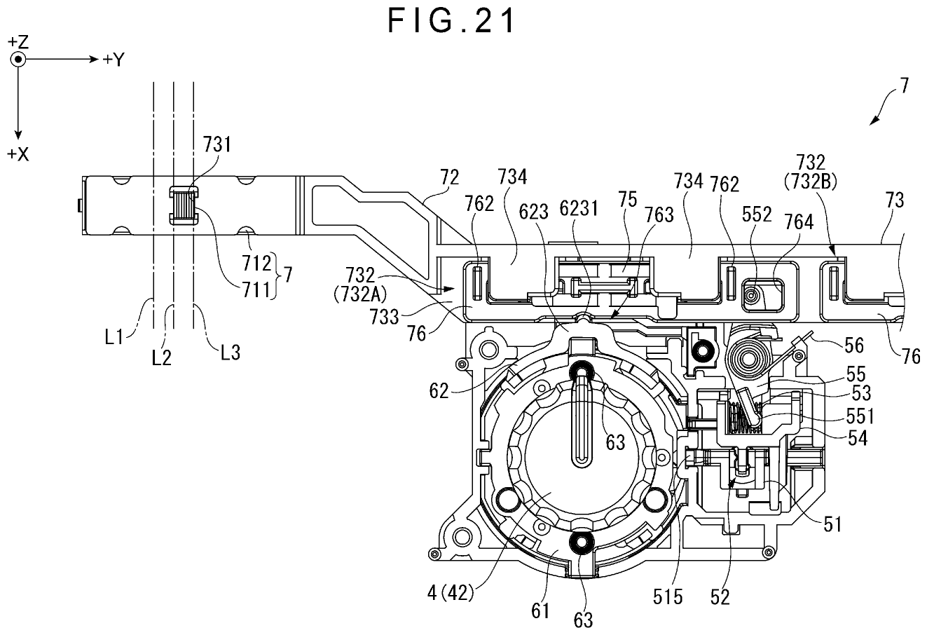

FIG. 21 is a plan view of the state switching mechanism 7 in a state in which the slide operator 711 is disposed at the second switching position. The chain lines L1 to L3 in FIG. 21 are the same as the chain lines L1 to L3 illustrated in FIG. 20.

As illustrated in FIG. 21, when an operation of disposing the slide operator 711 at the second switching position is performed, the holder 712 outputs, to the controller, an operation signal for switching the operation mode of the rotary operator 2, and thus the operation mode of the acoustic device 1, to a second mode. The controller to which the signal for switching the operation mode to the second mode is inputted switches the operation mode of the rotary operator 2 to the second mode.

When the slide operator 711 is disposed at the second switching position, the slide member 72 is disposed substantially in the middle in the movable range of the slide member 72.

In this case, the click plate 61 of the operational-feeling switching mechanism 6 is disposed at a position in which the protrusion 614 is fittable in the fitting portion 451 by the movement base 62. That is, the click plate 61 is disposed by the movement base 62 at a position where the clicking feeling occurs when the rotator 42 is rotated.

In contrast, as with the case where the slide operator 711 is disposed at the first switching position, the holding member 54 and the contact piece 51 are disposed at respective positions that are separated in the +Y direction from the rotator 42 by the switching member 55. Accordingly, the contact portion 515 is separated from the rotator 42, and thus the rotation of the rotator 42 that passes the reference position is not restricted by the contact piece 51.

In the exemplary embodiment, the second mode is an operation mode in which: when the rotator 42 is rotated in the +D direction from the reference position, an effect amount of a first effect is set in accordance with the rotation angle of the rotator 42 from the reference position toward the +D direction; and when the rotator 42 is rotated in the −D direction from the reference position, an effect amount of a second effect is set in accordance with the rotation angle of the rotator 42 from the reference position toward the −D direction. In the second mode, the clicking feeling occurs during the rotation operation of the rotator 42.

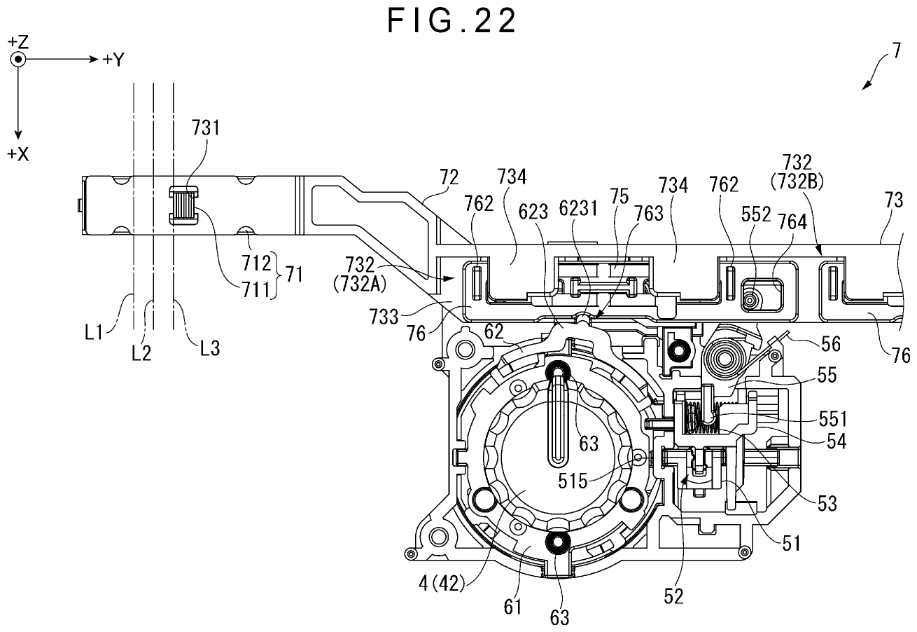

FIG. 22 is a plan view of the state switching mechanism 7 in a state in which the slide operator 711 is disposed at the third switching position. The chain lines L1 to L3 in FIG. 22 are the same as the chain lines L1 to L3 illustrated in FIG. 20.

As illustrated in FIG. 22, when an operation of disposing the slide operator 711 at the third switching position is performed, the holder 712 outputs, to the controller, an operation signal for switching the operation mode of the rotary operator 2, and thus the operation mode of the acoustic device 1, to the third mode.

When the slide operator 711 is disposed at the third switching position, the slide member 72 is disposed farthest in the +Y direction in the movable range of the slide member 72.

In this case, as with the case where the slide operator 711 is disposed at the second switching position, the click plate 61 of the operational-feeling switching mechanism 6 is disposed at a position in which the protrusion 614 is fittable in the fitting portion 451 by the movement base 62. That is, the click plate 61 is disposed by the movement base 62 at a position where the clicking feeling occurs when the rotator 42 is rotated.

Further, when the slide member 72 is disposed at the third switching position, the biasing in the +Y direction on the holding member 54 by the switching member 55 is released, with the switching member 55 being rotated clockwise as viewed from the +Z direction by the slide member 72. Accordingly, the holding member 54 is biased in the −Y direction by the second biasing member 53, and the contact piece 51 is thus biased toward the rotation axis Rx. This causes the contact portion 515 to come into contact with the rotator 42. The contact portion 515 moves along the movement paths RT1 and RT2 in association with the rotation of the rotator 42, and the rotation of the rotator 42 that passes the reference position is restricted.

As described above, in the third mode, the clicking feeling occurs during the rotation operation of the rotator 42. In contrast, unlike the case in the second mode, the rotation of the rotator 42 that passes the reference position is restricted in the third mode.

It is to be noted that in the exemplary embodiment, as with the second mode, the third mode is an operation mode in which the effect amount of the first effect is set in accordance with the rotation angle of the rotator 42 from the reference position toward the +D direction, and the effect amount of the second effect is set in accordance with the rotation angle of the rotator 42 from the reference position toward the −D direction. Accordingly, upon adjustment of the effect amount of one of the first effect and the second effect, a case of erroneously adjusting the effect amount of the other effect is prevented.

As described above, by slidingly moving in the ±Y directions the slide operator 711 that is an operation dial exposed on the top surface 11A of the casing 11, it is possible to not only switch the operation modes of each of the rotary operators 2 that configure effect adjusters 157A to 157D, but also to simultaneously switch the operational feelings of each of the rotary operators 2 and the restricted states of each of the rotary operators 2.

### Effects of First Exemplary Embodiment

It is possible for the acoustic device 1 according to the exemplary embodiment described above to achieve the following effects.

The acoustic device 1 includes the rotary operator 2 that is an operator, the state switching mechanism 7, and the operational-feeling switching mechanism 6. The state switching mechanism 7 switches operation modes of the rotary operator 2 in response to the switching operation on the state switching mechanism 7. The operational-feeling switching mechanism 6 switches the operational feelings of the rotary operator 2 in response to the switching operation on the state switching mechanism 7, along with the switching of the operation modes performed by the state switching mechanism 7.

With such a configuration, both the switching of the operation modes of the rotary operator 2 and the switching of the operational feelings of the rotary operator 2 are performed by the switching operation on the state switching mechanism 7. According to this, both the switching of the operation modes and the switching of the operational feelings of the rotary operator 2 are performable by a single switching operation. It is therefore possible to improve usability of the acoustic device 1.

The acoustic device 1 includes multiple rotary operators 2. The operational-feeling switching mechanism 6 is provided correspondingly to each of the multiple rotary operators 2. The state switching mechanism 7 switches the operation modes of each of the multiple rotary operators 2, and causes the multiple operational-feeling switching mechanisms 6 to operate.

With such a configuration, both the switching of the operation modes and the switching of the operational feelings of each of the rotary operators 2 are performable by a single switching operation. It is therefore possible to improve usability of the acoustic device 1.

In the acoustic device 1, the operational-feeling switching mechanism 6 performs switching of the operational feelings between the state in which the clicking feeling occurs when the operator is operated and the state in which no clicking feeling occurs when the operator is operated.

With such a configuration, it is possible to improve usability of the rotary operator 2, and is thus possible to improve usability of the acoustic device 1.

In the acoustic device 1, the state switching mechanism 7 includes the slide switch 71 and the slide member 72. The slide switch 71 includes the slide operator 711 and switches the operation modes of the rotary operator 2 in accordance with a position of the slide operator 711. The slide member 72 is slidable with the slide operator 711. The operational-feeling switching mechanism 6 includes the engagement portion 7231 that engages with the slide member 72.

With such a configuration, sliding the slide operator 711 makes it possible to perform the switching of the operation modes of the rotary operator 2 by the slide switch 71, and the switching of the operational feelings of the rotary operator 2 by the operational-feeling switching mechanism 6 that engages with the slide member 72 which slides with the slide operator 711. It is therefore possible to improve usability of the acoustic device 1.

In the acoustic device 1, the rotary operator 2 includes the rotator 42 that rotates about the rotation axis Rx. The operational-feeling switching mechanism 6 includes the click plate 61 and the movement base 62. The click plate 61 corresponds to an engagement member, and is engageable with the rotator 42. The movement base 62 corresponds to a drive member, includes the engagement portion 6231, and moves the click plate 61 closer to or away from the cylindrical portion 45 of the rotator 42 in association with sliding of the slide member 72. The click plate 61 has the protrusion 614, and the rotator 42 has the fitting portion 451 in which the protrusion 614 is fittable.

With such a configuration, sliding the slide member 72 by operating the slide operator 711 makes it possible to switch the disposition position of the click plate 61 between a position where the protrusion 614 is fittable in the fitting portion 451 and a position where the protrusion 614 is not fittable in the fitting portion 451. When the click plate 61 is disposed at the position where the protrusion 614 is fittable in the fitting portion 451, the protrusion 614 fits into the fitting portion 451 in association with the rotation of the rotator 42, thereby making it possible to cause the clicking feeling to occur when the rotation operation is performed on the rotator 42, that is, when the rotary operator 2 is operated. It is thus possible to perform switching between a case where the clicking feeling occurs when the rotary operator 2 is operated and a case where no clicking feeling occurs when the rotary operator 2 is operated.

The acoustic device 1 includes the contact piece 51 and the switching member 55. The contact piece 51 comes into contact with the rotary operator 2 and restricts the rotation of the rotator 42. The switching member 55 switches the position of the contact piece 51 between the position at which the contact piece 51 is accessible to the rotator 42 and the position at which the contact piece 51 is not accessible to the rotator 42, in response to the switching operation on the state switching mechanism 7, that is, the slide operation on the slide operator 711.

With such a configuration, in response to the switching operation on the state switching mechanism 7, it is possible to not only switch the operation modes and switch the operational feelings of the rotary operator 2, but also to switch the state of the rotary operator 2 between the state in which the rotation of the rotator 42 is restricted and the state in which the rotation of the rotator 42 is not restricted. It is therefore possible to further improve usability of the acoustic device 1.

In the acoustic device 1, the slide member 72 includes the first slide member 73, the biasing member 75, and the second slide member 76. The first slide member 73 engages with the slide operator 711. The second slide member 76 is provided on the first slide member 73 to be slidable along the ±Y directions that are the sliding directions of the first slide member 73. The biasing member 75 biases the second slide member 76 toward the first slide member 73. The switching member 55 is a lever that engages with the second slide member 76, and rotates in association with the slide movement of the second slide member 76 to switch the positions of the contact piece 51.

With such a configuration, the second slide member 76 that engages with the switching member 55 serving as the lever slides with respect to the first slide member 73, which makes it possible to prevent the position of the switching member 55 and the position of the slide member 72 from deviating from respective appropriate positions due to tolerances, etc. In particular, the tolerances tend to accumulate and increase as the number of components increases, which increases an error in an actual position of the switching member 55 with respect to a design position of the switching member 55 and an error in an actual position of the slide member 72 with respect to a design position of the slide member 72. In contrast, with the second slide member 76 sliding with respect to the first slide member 73, it is possible to absorb the tolerances of the respective members including, without limitation, the restriction switching mechanism 5 including the switching member 55, and the state switching mechanism 7 including the slide member 72. The biasing member 75 biases the second slide member 76 toward the first slide member 73, which makes it possible to maintain the second slide member 76 at an appropriate position.

### Second Exemplary Embodiment

Next, a second exemplary embodiment of the disclosure will be described.

An acoustic device according to the exemplary embodiment has a configuration similar to that of the acoustic device 1 according to the first exemplary embodiment, but is different from the acoustic device 1 according to the first exemplary embodiment in that a path forming portion included in a rotator of a rotary operator is different in configuration as compared with the acoustic device 1 according to the first exemplary embodiment. It is to be noted that, in the following description, the same or substantially the same portions as those already described are denoted by the same reference numerals, and the description thereof is omitted.

### Configuration of Rotary Operator

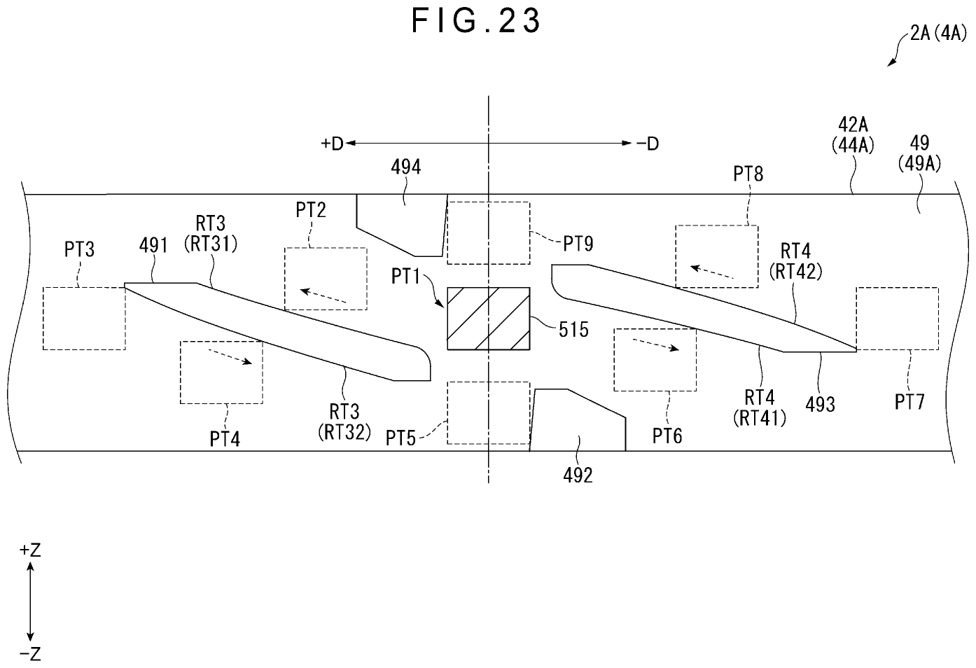

FIG. 23 is a schematic diagram illustrating a cylindrical portion 49 included in an operator body 4A of a rotary operator 2A included in the acoustic device according to the exemplary embodiment. FIG. 23 illustrates the contact portion 515 of the contact piece 51 that moves relatively to the operator body 4A along the cylindrical portion 49, and in addition, positions PT1 to PT8 at which the contact portion 515 may be disposed.

The acoustic device according to the exemplary embodiment has a configuration and a function similar to those of the acoustic device 1 according to the first exemplary embodiment except that the acoustic device according to the exemplary embodiment includes the rotary operator 2A illustrated in FIG. 23 instead of the rotary operator 2.

As with the rotary operator 2, the rotary operator 2A is an operator to be rotated about the rotation axis Rx by a user. The rotary operator 2A configures, for example, each of the effect adjusters 157A to 157D. The rotary operator 2A has a configuration and a function similar to those of the rotary operator 2 except that the rotary operator 2A includes the operator body 4A instead of the operator body 4.

### Configuration of Operator Body

As with the operator body 4 according to the first exemplary embodiment, the operator body 4A is a rotary volume which is to be rotated by the user and outputs a rotation angle with respect to a reference position. The operator body 4A includes the above-described base 41 and a rotator 42A.

The rotator 42A includes the above-described dial 43 and a rotating body 44A.

The rotating body 44A has a configuration similar to that of the rotating body 44 except that the rotating body 44A has the cylindrical portion 49 instead of the cylindrical portion 45.

The cylindrical portion 49 has a cylindrical shape about the rotation axis Rx of the rotator 42A in the rotating body 44A. The cylindrical portion 49 includes, on an outer circumferential surface 49A, path forming portions 491 and 493 and restricting portions 492 and 494. That is, the cylindrical portion 49 includes the path forming portions 491 and 493 and the restricting portions 492 and 494 each protruding radially outward about the rotation axis Rx from the outer circumferential surface 49A.

As with the path forming portions 47 and 48 described above, the path forming portions 491 and 493 respectively form movement paths RT3 and RT4 along which the contact portion 515 of the contact piece 51 moves relatively with respect to the rotator 42A when the rotator 42A is rotated about rotation axis Rx.

As with the path forming portion 47, the path forming portion 491 forms the movement path RT3 of the contact portion 515 when the rotator 42A is rotated in the counterclockwise-side range. The movement path RT3 is inclined with respect to the circumferential direction about the rotation axis Rx. That is, the outer circumferential surface 49A of the rotator 42A is provided with the movement path RT3 inclined with respect to the circumferential direction about the rotation axis Rx.

As with the restricting portion 481, when the rotator 42A disposed in the counterclockwise-side range is rotated in the +D direction, i.e., the clockwise direction, and reaches the reference position, the contact portion 515 moving in the −D direction comes into contact with the restricting portion 492, and the restricting portion 492 restricts the movement in the −D direction of the contact portion 515 and thus the rotation in the +D direction of the rotator 42A.

As with the path forming portion 48, the path forming portion 493 forms the movement path RT4 of the contact portion 515 when the rotator 42A disposed in the clockwise-side range is rotated. The movement path RT4 is inclined with respect to the circumferential direction about the rotation axis Rx. That is, the outer circumferential surface 49A of the rotator 42A is provided with the movement path RT4 inclined with respect to the circumferential direction about the rotation axis Rx.

As with the restricting portion 471, when the rotator 42A disposed in the clockwise-side range is rotated in the −D direction and reaches the reference position, the contact portion 515 moving in the +D direction comes into contact with the restricting portion 494, and the restricting portion 494 restricts the movement in the +D direction of the contact portion 515 and thus the rotation in the −D direction of the rotator 42A.

As with the path forming portion 48, the path forming portion 493 forms the movement path RT4 of the contact portion 515 when the rotator 42A is rotated in the clockwise-side range. The path forming portion 491 and the path forming portion 493 are provided on the outer circumferential surface 49A to be point-symmetric about a position PT1. Similarly, the restricting portion 492 and the restricting portion 494 are provided on the outer circumferential surface 49A to be point-symmetric about the position PT1.

### Movement Path of Contact Portion

The path forming portion 491 is inclined with respect to the +D direction and the +Z direction in such a manner as to be located in the +Z direction toward the +D direction. A surface in the +Z direction of the path forming portion 491 forms a first path RT31, of the movement path RT3, along which the contact portion 515 disposed at the position PT1 in the counterclockwise-side range moves in the +D direction to reach a second path RT32. A surface in the −Z direction of the path forming portion 491 forms a portion of the second path RT32, of the movement path RT3, along which the contact portion 515 having reached the movement limit in the +D direction in the counterclockwise-side range moves to reach the restricting portion 492. A length in the +D direction of the first path RT31 is approximately the same as a length in the +D direction of the second path RT32. It is to be noted that a surface in the +Z direction forming the first path RT31 in the path forming portion 491 and a surface in the −Z direction forming the portion of the second path RT32 in the path forming portion 491 are each inclined with respect to the circumferential direction about the rotation axis Rx.

If the rotator 42A located at the reference position is rotated in the −D direction, the contact portion 515 moves along the first path RT31 and reaches, for example, a position PT2. In a state in which the contact portion 515 is located on the first path RT31, when the rotator 42A is rotated in the +D direction, the contact portion 515 moves relatively in the −D direction along the first path RT31. In this case, the contact portion 515 does not come into contact with the restricting portion 492, and thus the rotation of the rotator 42A that passes the reference position is not restricted.

When the rotator 42A is further rotated in the −D direction and the contact portion 515 reaches a movement limit in the −D direction in the counterclockwise-side range, the contact portion 515 and the path forming portion 491 are separated from each other, and the contact portion 515 reaches the second path RT32 that couples the movement limit in the +D direction and a position PT5 (the first position in the counterclockwise-side range). At this time, a position in the +Z direction of the contact portion 515 matches a position in the +Z direction of the contact portion 515 when the contact piece 51 is disposed at the position PT1 owing to the biasing force of the first biasing member 52. Accordingly, when the rotator 42A is rotated to the rotation limit in the −D direction in the state in which the contact portion 515 is separated from the path forming portion 491, the contact portion 515 is moved to the movement limit in the +D direction along the second path RT32 with the position in the +Z direction unchanged.

Here, an end in the +D direction of the path forming portion 491 is located in the +Z direction relative to an end in the +Z direction of the contact portion 515 when the contact piece 51 is disposed at the position PT1. Thus, when the rotator 42A is rotated in the +D direction from the rotation limit in the −D direction, the contact portion 515 comes into contact with a surface on the −Z direction of the path forming portion 491 as indicated by a position PT3. When the rotator 42A is further rotated in the +D direction, the contact portion 515 reaches a position PT4.

In a state in which the contact portion 515 is disposed on the second path RT32, when the rotator 42A is rotated in the +D direction and reaches the reference position, the contact portion 515 reaches the position PT5 that is in contact with the restricting portion 492 provided on an extension of the second path RT32. A position of the contact piece 51 when the contact portion 515 is disposed at the position PT5 corresponds to the first position in the counterclockwise-side range. Movement in the −D direction of the contact portion 515 having reached the position PT5 is restricted by the restricting portion 492, and thus the rotation in the +D direction of the rotator 42A is restricted. That is, the rotation of the rotator 42A in the +D direction from the reference position is restricted by the contact piece 51 being at the first position in the counterclockwise-side range.

If rotating force in the +D direction applied to the rotator 42A is reduced by, for example, the user releasing his or her finger from the dial 43, in the state in which the contact piece 51 is located at the first position, the contact portion 515 returns to the position PT1 owing to the biasing force in the +Z direction of the first biasing member 52. The position of the contact piece 51 when the contact portion 515 is disposed at the position PT1 corresponds to the second position. This allows relative movement in the −D direction of the contact portion 515, and thus the rotation in the +D direction of the rotator 42A that passes the reference position.

The path forming portion 493 is inclined with respect to the −D direction and the −Z direction in such a manner as to be located in the −Z direction toward the −D direction. A surface in the −Z direction of the path forming portion 493 forms a first path RT41, of the movement path RT4, along which the contact portion 515 disposed at the position PT1 in the clockwise-side range moves in the −D direction to reach a second path RT42. A surface in the +Z direction of the path forming portion 491 forms a portion of the second path RT42, of the movement path RT4, along which the contact portion 515 having reached the movement limit in the −D direction in the clockwise-side range moves to reach the restricting portion 494. A length in the +D direction of the first path RT41 is approximately the same as a length in the −D direction of the second path RT42. It is to be noted that a surface in the −Z direction forming the first path RT41 in the path forming portion 493 and a surface in the +Z direction forming the portion of the second path RT42 in the path forming portion 493 are each inclined with respect to the circumferential direction about the rotation axis Rx.

If the rotator 42A located at the reference position is rotated in the +D direction, the contact portion 515 moves along the first path RT41 from the position PT1, and reaches, for example, a position PT6. In a state in which the contact portion 515 is located on the first path RT41, when the rotator 42A is rotated in the −D direction, the contact portion 515 moves relatively in the +D direction along the first path RT41. In this case, the contact portion 515 does not come into contact with the restricting portion 494, and thus the rotation of the rotator 42A that passes the reference position is not restricted.

When the rotator 42A is further rotated in the +D direction and the contact portion 515 reaches a movement limit in the +D direction in the clockwise-side range, the contact portion 515 and the path forming portion 493 are separated from each other, and the contact portion 515 reaches the second path RT42 that couples the movement limit in the −D direction and a position PT9 (the first position in the clockwise-side range). At this time, a position in the +Z direction of the contact portion 515 matches a position in the +Z direction of the contact portion 515 when the contact piece 51 is disposed at the position PT1 owing to the biasing force of the first biasing member 52. Accordingly, when the rotator 42A is rotated to the rotation limit in the +D direction in the state in which the contact portion 515 is separated from the path forming portion 493, the contact portion 515 is moved to the movement limit in the −D direction along the second path RT42 with the position in the +Z direction unchanged.

Here, an end in the −D direction of the path forming portion 493 is located in the −Z direction relative to an end in the −Z direction of the contact portion 515 when the contact piece 51 is disposed at the position PT1. Thus, when the contact portion 515 is moved in the +D direction by the rotator 42A being rotated in the −D direction, the contact portion 515 comes into contact with a surface in the +Z direction of the path forming portion 493 as indicated by a position PT7. When the rotator 42A is further rotated in the −D direction, the contact portion 515 reaches a position PT8.

In a state in which the contact portion 515 is disposed on the second path RT42, when the rotator 42A is rotated in the −D direction and reaches the reference position, the contact portion 515 reaches the position PT9 that is in contact with the restricting portion 494 provided on an extension of the second path RT42. A position of the contact piece 51 when the contact portion 515 is disposed at the position PT9 corresponds to the first position in the clockwise-side range. Movement in the +D direction of the contact portion 515 having reached the position PT9 is restricted by the restricting portion 494, and thus the rotation in the −D direction of the rotator 42A is restricted. That is, the rotation of the rotator 42A in the −D direction from the reference position is restricted by the contact piece 51 being at the first position in the clockwise-side range.

If rotating force in the −D direction applied to the rotator 42A is reduced by, for example, the user releasing his or her finger from the dial 43, in the state in which the contact piece 51 is located at the first position, the contact portion 515 returns to the position PT1 owing to the biasing force in the −Z direction of the first biasing member 52. As described above, the position of the contact piece 51 when the contact portion 515 is disposed at the position PT1 corresponds to the second position. This allows relative movement in the +D direction of the contact portion 515, and thus the rotation in the −D direction of the rotator 42A that passes the reference position.

As described above, the rotator 42A has a cylindrical cam structure in which the movement paths RT3 and RT4 are provided. The movement paths RT3 and RT4 each allow the contact piece 51 to move in a direction along the rotation axis Rx when the rotator 42A is rotated about the rotation axis Rx.

It is to be noted that, in the exemplary embodiment, the path forming portion 491 that configures the second path RT32 and the path forming portion 493 that configures the second path RT42 are not provided in the vicinity of the first position, and thus, the contact piece 51 is movable to the second position at a timing at which the contact piece 51 reaches the first position. In the rotary operator 2A according to the exemplary embodiment also, as with the rotary operator 2 according to the first exemplary embodiment, it is possible to keep a balance regarding ease of movement of the contact piece 51 from the first position to the second position.

For example, it is possible to make it difficult for the contact piece 51 to return to the second position by, for example, increasing in the distance between the first position and the second position.

Further, it is possible to make it difficult for the contact piece 51 to return to the second position by, for example, by controlling movement rate in the ±Z directions of the contact piece 51 with use of a viscous lubricant, etc.

It is possible for the acoustic device according to the exemplary embodiment described above to have effects similar to those of the acoustic device 1 according to the first exemplary embodiment.

### Modifications of Exemplary Embodiment

The disclosure is not limited to the above exemplary embodiments, and modifications and improvements within the scope of achieving the disclosure objects are included in the disclosure.

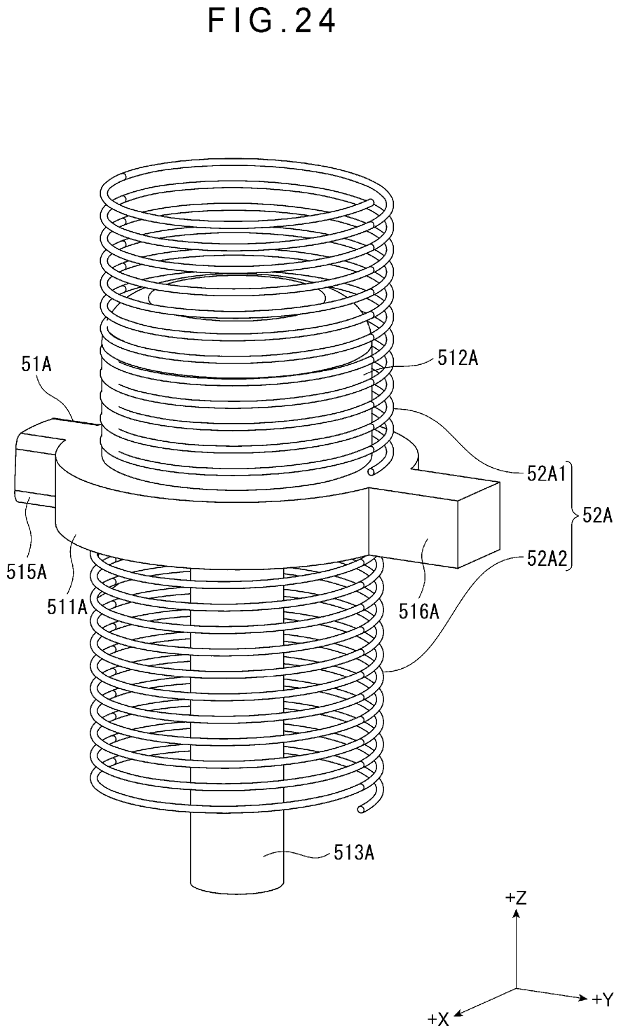

FIG. 24 is a perspective view illustrating a contact piece 51A and a first biasing member 52A that are modifications of the contact piece 51 and the first biasing member 52.

In the above-described exemplary embodiments, the first biasing member 52 is one compression coil spring, and the contact piece 51 is biased by the first biasing member 52. However, the disclosure is not limited thereto, and the first biasing member 52 may include, for example, a compression coil spring 52A1 provided in the +Z direction and a compression coil spring 52A2 provided in the −Z direction as illustrated in FIG. 24, for example.

Further, instead of the contact piece 51, the contact piece 51A illustrated in FIG. 24, for example, may be employed. The contact piece 51A includes a contact piece body 511A, a contact portion 515A protruding in the −Y direction from the contact piece body 51A1 to come into contact with the rotator 42, and a protrusion 516A protruding in the +Y direction from the contact piece body 51A1 to be inserted into the guide 344. The contact piece body 511A includes a protrusion 512A protruding in the +Z direction to be inserted into the compression coil spring 52A1, and a protrusion 513A protruding in the −Z direction to be inserted into the compression coil spring 52A2.

If a clamp portion that clamps the contact piece 51A and the first biasing member 52A in the +Z direction is provided in the casing 3, it is possible to bias the contact portion 515A in such a manner as to be disposed on the bottom 461 of the recess 46 or at the position PT1 owing to the biasing force of the first biasing member 52A.

In the above-described first exemplary embodiment, the rotator 42 includes the path forming portions 47 and 48. In the above-described second exemplary embodiment, the rotator 42A includes the path forming portions 491 and 493 and the restricting portions 492 and 494. However, the disclosure is not limited thereto, and the rotator 42 may include one of the path forming portion 47 and the path forming portion 48. In this case, the restricting portion 481 may be provided separately. Similarly, the rotator 42A may include one of the following combinations: the path forming portion 491 and the restricting portion 492; and the path forming portion 493 and the restricting portion 494.

In the above-described first exemplary embodiment, the restricting portion 471 includes the guide surface 473, and the restricting portion 481 includes the guide surface 483. However, the disclosure is not limited thereto, and the restricting portions 471 and 481 may not include the guide surfaces 473 and 483 depending on configurations of the path forming portions 47 and 48.

In the above-described exemplary embodiments, the rotary operators 2 and 2A each include the first biasing member 52 that biases the contact piece 51 in the direction from the first position toward the second position. However, the disclosure is not limited thereto, and the first biasing members 52 and 52A may be omitted as long as it is possible to locate the contact piece 51 being in contact with the restricting portions 471, 481, 492, and 494 at the second position when the rotating force applied to the rotators 42 and 42A is reduced. Further, the first biasing members 52 and 52A may not be configured by the compression coil spring, and may be configured by other members such as magnets.

In the above-described first exemplary embodiment, the path forming portion 47 that forms the movement path RT1 and the path forming portion 48 that forms the movement path RT2 protrude radially outward about the rotation axis Rx from the outer circumferential surface 45A. In the above-described second exemplary embodiment, the path forming portion 491 that forms the movement path RT3, the path forming portion 493 that forms the movement path RT4, and the restricting portions 492 and 494 protrude radially outward about the rotation axis Rx from the outer circumferential surface 49A. However, the disclosure is not limited thereto, and the movement path along which the contact piece 51 moves may be formed by a trench provided in the outer circumferential surface of the rotator.

In the above-described exemplary embodiments, the first biasing member 52 biases the contact piece 51 in the +Z direction and the −Z direction along the rotation axis Rx. However, the disclosure is not limited thereto, and the direction in which the first biasing member 52 biases may not necessarily be a direction along the rotation axis Rx. That is, the direction in which the first biasing members 52 and 52A bias the contact piece 51 may be another direction as long as it is possible to return the contact piece 51 being in contact with the restricting portions 471, 481, 492, and 494 to the second position.

In the above-described first exemplary embodiment, the second path RT12 is longer in the +D direction than the first path RT11, and the second path RT22 is longer in the −D direction than the first path RT21. However, the disclosure is not limited thereto, and the first path RT11 may be longer in the +D direction than the second path RT12, and the first path RT21 may be longer in the −D direction than the second path RT22. Alternatively, as with the first paths RT31 and RT41 and the second paths RT32 and RT42 according to the second exemplary embodiment, the length in the +D direction of the first path RT11 may be substantially the same as the length in the +D direction of the second path RT12, and the length in the −D direction of the first path RT21 may be substantially the same as the length in the −D direction of the second path RT22.

In the above-described exemplary embodiments, the rotary operators 2 and 2A each include the second biasing member 53 that biases the contact piece 51 toward the rotation axis Rx of the rotator 42. However, the disclosure is not limited thereto, and the second biasing member 53 may be omitted as long as the rotary operators 2 and 2A each do not include the state switching mechanism 7 and each have a configuration in which the rotation of the rotators 42 and 42A that passes the reference position is restricted.

Further, the contact piece 51 does not necessarily have to be in contact with the outer circumferential surfaces 45A and 49A of the rotators 42 and 42A.

In the above-described exemplary embodiments, the rotary operator 2 serving as an operator is the operator that is rotatable about the rotation axis Rx. However, the disclosure is not limited thereto, and the operator according to the disclosure may be a rectilinear operator. Further, the rotation axis Rx may not be the rotation axis along the +Z direction, and may be, for example, a rotation axis along the +X direction or a rotation axis along the +Y direction.

In the above-described exemplary embodiments, the acoustic device includes the multiple rotary operators 2, and the operational-feeling switching mechanism 6 is provided correspondingly to each of the multiple rotary operators 2. Further, the state switching mechanism 7 causes the multiple operational-feeling switching mechanisms 6 to operate. However, the disclosure is not limited thereto, and the acoustic device may include one rotary operator. Further, even when multiple rotary operators 2 are provided, the state switching mechanism 7 may switch the operation modes of at least one of the multiple rotary operators 2, and may cause the operational-feeling switching mechanism 6 provided corresponding to the at least one rotary operator 2 to operate.

In the above-described exemplary embodiments, the operational-feeling switching mechanism 6 performs switching between the state in which the clicking feeling occurs when the rotary operator 2 is rotated and the state in which no clicking feeling occurs when the rotary operator 2 is rotated. However, the disclosure is not limited thereto, and the operational-feeling switching mechanism may adjust rotation resistance of the rotary operator 2 to switch between a state in which the rotation resistance is high and a state in which the rotation resistance is low. In other words, the operational-feeling switching mechanism may perform switching between a state in which moving resistance of operator is high and a state in which the moving resistance is low. That is, as long as it is possible for the operational-feeling switching mechanism of the disclosure to give different operational feelings to the user when the user operates the operator, the kinds of operational feelings are not limited.

In the above-described exemplary embodiments, the state switching mechanism 7 includes the slide switch 71 including the slide operator 711, and the slide member 72 slidable with the slide operator 711. However, the disclosure is not limited thereto, and the configuration of the state switching mechanism 7 is not limited to the above. For example, instead of the slide switch 71, a sensor that detects a position of the slide member 72 may be provided. The sensor may switch the operation modes in accordance with the position of the slide member 72.

Further, the slide operator 711 is allocatable at one switching position out of the first switching position, the second switching position, and the third switching position. However, the disclosure is not limited thereto, the slide operator 711 may be allocatable at two or more positions.

In the above-described exemplary embodiments, the movement base 62 serving as a drive member engages with the slide member 72 and rotates about the rotation axis Rx to move the click plate 61 serving as an engagement member. However, the disclosure is not limited thereto, and the movement base 62 does not necessarily have to rotate. For example, the movement base 62 may move linearly to move the click plate 61, and the slide member 72 may move the click plate 61.

Further, the configuration is not limited to that in which the click plate 61 has the protrusion 614 and the rotator 42 has the fitting portion 451. The click plate 61 may have a fitting portion and the rotator 42 may have a protrusion. Further, the operational-feeling switching mechanism 6 does not necessarily have to include the biasing member 63.

In the above-described exemplary embodiments, the acoustic device is provided with the restriction switching mechanism 5 including the contact pieces 51 and 51A and the switching member 55. However, the restriction switching mechanism 5 may be absent. Further, the restriction on the rotator 42 performed by the restriction switching mechanism may be performed by another component.

In the above-described exemplary embodiments: the slide member 72 includes the first slide member 73, the biasing member 75, and the second slide member 76; and the switching member 55 is the lever that is rotatably supported by the casing 3 and switches the positions of the contact piece 51 or 51A. However, the disclosure is not limited thereto, and the biasing member 75 and the second slide member 76 may be absent. For example, the restriction switching mechanism 5 and the operational-feeling switching mechanism 6 may engage with the first slide member 73, and the first slide member 73 may cause the restriction switching mechanism 5 and the operational-feeling switching mechanism 6 to operate.

Further, the switching member 55 is not limited to the lever, and the contact pieces 51 and 51A may each be disposed at a position that moves closer to or a position that moves away from the rotator 42 by another component.

In the above-described exemplary embodiments, the rotary operators 2 and 2A that are each the operator, the operational-feeling switching mechanism 6, and the state switching mechanism 7 are employed in the acoustic device that is the mixer. However, the disclosure is not limited thereto, and the acoustic device of the disclosure may be another acoustic device such as a DJ controller.

### Conclusion of Disclosure

A conclusion of the disclosure is described below.

[1] An acoustic device includes: an operator; a state switching mechanism configured to perform switching of operation modes of the operator in response to a switching operation; and an operational-feeling switching mechanism configured to perform switching of operational feelings of the operator in response to the switching operation, along with the switching of the operation modes performed by the state switching mechanism.

With such a configuration, both the switching of the operation modes of the operator and the switching of the operational feelings of the operator are performed by the switching operation on the state switching mechanism. According to this, both the switching of the operation modes and the switching of the operational feelings of the operator are performable by a single switching operation. It is therefore possible to improve usability of the acoustic device.

[2] In the acoustic device according to [1], the operator may include a plurality of operators, the operational-feeling switching mechanism may be provided correspondingly to each of the plurality of operators, and the state switching mechanism may perform the switching of the operation modes of each of the plurality of operators, and cause a plurality of the operational-feeling switching mechanisms to operate.

With such a configuration, both the switching of the operation modes and the switching of the operational feelings of each of the plurality of operators are performable by a single switching operation. It is therefore possible to improve usability of the acoustic device.

[3] In the acoustic device according to [1] or [2], the operational-feeling switching mechanism may perform the switching of the operational feelings between a state in which a clicking feeling occurs when the operator is operated and a state in which no clicking feeling occurs when the operator is operated.

With such a configuration, it is possible to improve usability of the operator, and is thus possible to improve usability of the acoustic device.

[4] In the acoustic device according to any one of [1] to [3], the state switching mechanism may include a slide switch including a slide operator and being configured to perform the switching of the operation modes in accordance with a position of the slide operator, and a slide member that is slidable with the slide operator, and the operational-feeling switching mechanism may include an engagement portion configured to engage with the slide member.

With such a configuration, sliding the slide operator makes it possible to perform the switching of the operation modes of the operator by the slide switch and the switching of the operational feelings of the operator by the operational-feeling switching mechanism that engages with the slide member which slides with the slide operator. It is therefore possible to improve usability of the acoustic device.

[5] In the acoustic device according to [4], the operator may include a rotational operator including a rotator configured to rotate about a rotation axis, the operational-feeling switching mechanism may include an engagement member that is engageable with the rotator, and a drive member including the engagement portion, and being configured to move the engagement member closer to or away from the rotator in association with sliding of the slide member, one of the engagement member and the rotator may have a protrusion, and the other of the engagement member and the rotator may have a fitting portion in which the protrusion is fittable.

With such a configuration, sliding the slide member by operating the slide operator makes it possible to switch the disposition position of the engagement member between a position where the protrusion is fittable in the fitting portion and a position where the protrusion is not fittable in the fitting portion. When the engagement member is disposed at the position where the protrusion is fittable in the fitting portion, the protrusion fits into the fitting portion in association with the rotation of the rotator, thereby making it possible to cause the clicking feeling to occur when the rotation operation is performed on the rotator, that is, when the operator is operated. It is thus possible to perform switching between a case where the clicking feeling occurs when the operator is operated and a case where no clicking feeling occurs when the operator is operated.

[6] The acoustic device according to [5] may further include: a contact piece configured to come into contact with the rotator and restrict rotation of the rotator; and a switching member configured to perform, in response to the switching operation, switching of positions of the contact piece between a position at which the contact piece is accessible to the rotator and a position at which the contact piece is not accessible to the rotator.

With such a configuration, in response to the switching operation on the state switching mechanism, it is possible to not only switch the operation modes and switch the operational feelings of the operator, but also to switch the state of the operator between the state in which the rotation of the rotator is restricted and the state in which the rotation of the rotator is not restricted. It is therefore possible to further improve usability of the acoustic device.

[7] In the acoustic device according to [6], the slide member may include a first slide member configured to engage with the slide operator, a second slide member provided on the first slide member to be slidable along a sliding direction of the first slide member, and a biasing member configured to bias the second slide member toward the first slide member, and the switching member may include a lever configured to engage with the second slide member and rotate in association with a slide movement of the second slide member to perform the switching of the positions of the contact piece.

With such a configuration, the second slide member that engages with the switching member serving as the lever slides with respect to the first slide member, which makes it possible to prevent the position of the switching member and the position of the slide member from deviating from respective appropriate positions due to tolerances, etc. In particular, the tolerances tend to accumulate and increase as the number of components increases, which increases an error in an actual position of the switching member with respect to a design position of the switching member and an error in an actual position of the slide member with respect to a design position of the slide member. In contrast, with the second slide member sliding with respect to the first slide member, it is possible to absorb the tolerances of the respective members including, without limitation, the switching member and the slide member. The biasing member biases the second slide member toward the first slide member, which makes it possible to maintain the second slide member at an appropriate position.

### EXPLANATION OF CODES

1 . . . acoustic device, 2, 2A . . . rotary operator (operator), 4, 4A . . . operator body, 42, 42A . . . rotator, 451 . . . fitting portion, 5 . . . restriction switching mechanism, 51, 51A . . . contact piece, 55 . . . switching member (lever), 6 . . . operational-feeling switching mechanism, 61 . . . click plate (engagement member), 614 . . . protrusion, 62 . . . movement base (drive member), 6231 . . . engagement portion, 7 . . . state switching mechanism, 71 . . . slide switch, 711 . . . slide operator, 72 . . . slide member, 73 . . . first slide member, 75 . . . biasing member, 76 . . . second slide member

1. An acoustic device comprising:
an operator;
a state switching mechanism configured to perform switching of operation modes of the operator in response to a switching operation; and
an operational-feeling switching mechanism configured to perform switching of operational feelings of the operator in response to the switching operation, along with the switching of the operation modes performed by the state switching mechanism.

2. The acoustic device according to claim 1, wherein
the operator comprises a plurality of operators,
the operational-feeling switching mechanism is provided correspondingly to each of the plurality of operators, and
the state switching mechanism performs the switching of the operation modes of each of the plurality of operators, and causes a plurality of the operational-feeling switching mechanisms to operate.

3. The acoustic device according to claim 1, wherein the operational-feeling switching mechanism performs the switching of the operational feelings between a state in which a clicking feeling occurs when the operator is operated and a state in which no clicking feeling occurs when the operator is operated.

4. The acoustic device according to claim 1, wherein
the state switching mechanism comprises
a slide switch comprising a slide operator and being configured to perform the switching of the operation modes in accordance with a position of the slide operator, and
a slide member that is slidable with the slide operator, and
the operational-feeling switching mechanism comprises an engagement portion configured to engage with the slide member.

5. The acoustic device according to claim 4, wherein
the operator comprises a rotational operator including a rotator configured to rotate about a rotation axis,
the operational-feeling switching mechanism comprises
an engagement member that is engageable with the rotator, and
a drive member comprising the engagement portion, and being configured to move the engagement member closer to or away from the rotator in association with sliding of the slide member,
one of the engagement member and the rotator has a protrusion, and
the other of the engagement member and the rotator has a fitting portion in which the protrusion is fittable.

6. The acoustic device according to claim 5, further comprising:
a contact piece configured to come into contact with the rotator and restrict rotation of the rotator; and
a switching member configured to perform, in response to the switching operation, switching of positions of the contact piece between a position at which the contact piece is accessible to the rotator and a position at which the contact piece is not accessible to the rotator.

7. The acoustic device according to claim 6, wherein
the slide member comprises
a first slide member configured to engage with the slide operator,
a second slide member provided on the first slide member to be slidable along a sliding direction of the first slide member, and
a biasing member configured to bias the second slide member toward the first slide member, and
the switching member comprises a lever configured to engage with the second slide member and rotate in association with a slide movement of the second slide member to perform the switching of the positions of the contact piece.
